(19) United States
(12) Patent Application Publication
(10) Pub. No.: US 2026/0370679 A1
(43) Pub. Date: Nov. 19, 2026

(54) SYSTEMS AND METHODS FOR USING KNOWLEDGESLESS DATA PROFILES

(71) Applicant: Dark Watch, Stuart, FL (US)

(72) Inventors: Noel THOMAS, Stuart, FL (US); Keith JOHNSON, Stuart, FL (US); Robert REED, Stuart, FL (US)

(73) Assignee: Dark Watch, Stuart, FL (US)

(21) Appl. No.: 19/207,256

(22) Filed: May 13, 2025

(51) Int. Cl. H04L 9/40

(52) U.S. Cl. CPC H04L 63/1441; H04L 63/1425; H04L 2463/041

(57) ABSTRACT

Systems and methods for using knowledgeless data profiles for real-time detection and sanitized communications. For example, the system may retrieve a first knowledgeless data profile, wherein the first knowledgeless data profile comprises a first privacy-preserving, cryptographically encoded representation of a first user. The system may determine that the first token corresponds to a first indicium of the first knowledgeless data profile, wherein the first indicium represents a first portion of the first privacy-preserving, cryptographically encoded representation. The system may, in response to determining that the first token corresponds to the first indicium, generate a first group comprising the first user.

### BACKGROUND

Real-time sharing of information is critical for stopping cyber-crimes, electronic crimes, and scams because these threats often unfold rapidly and evolve dynamically, exploiting time-sensitive vulnerabilities across systems and users. Cybercriminals frequently use automated tools to launch phishing attacks, distribute malware, or exfiltrate data within minutes of breaching a system. Without immediate awareness and communication, affected organizations or individuals may remain unaware of an active threat until significant damage has already occurred. By sharing threat intelligence in real time—such as indicators of compromise (IP addresses, malicious URLs, or suspicious file hashes), attack vectors, or newly observed phishing techniques—security teams across different organizations can take swift, proactive measures to block or mitigate the threat. For example, if one company detects a ransomware campaign targeting financial systems, that information can help others patch vulnerabilities, isolate assets, and update intrusion detection rules before they are attacked. Additionally, real-time coordination supports law enforcement and incident response teams in tracing human traffickers, shutting down fraudulent infrastructure, and alerting potential victims. In an era where cyber threats and online crimes are increasingly automated, decentralized, and global, timely information sharing is not just a best practice—it is a fundamental defense mechanism that enables the broader ecosystem to act collectively and effectively against digital threats.

Unfortunately, users—and particularly industry entities—are often reluctant to share information about cyber-crimes, electronic crimes, and scams due to concerns over reputational damage, legal liability, competitive disadvantage, and regulatory scrutiny. Publicly disclosing that a breach or scam occurred can lead to a loss of customer trust, stock devaluation, and negative media coverage, all of which can have long-term financial consequences. Companies may also fear that sharing specific technical details about an incident could expose weaknesses in their systems, potentially inviting further attacks or undermining their competitive position. Additionally, uncertainty about legal ramifications—such as potential lawsuits, compliance violations, or contractual breaches—can discourage transparency. In industries with strict data protection laws, such as healthcare or finance, organizations may be unsure how much they are legally permitted to share, especially when sensitive, personal, and/or personally identifiable information (“PII”) is involved. There is also a lack of standardized mechanisms or trusted forums for sharing threat intelligence safely and anonymously, further complicating collaboration. As a result, many entities opt to handle incidents internally or through private channels, which limits the broader cybersecurity community's ability to respond quickly, coordinate defenses, and learn from emerging threats.

Creating standardized mechanisms or trusted forums for sharing threat intelligence safely and anonymously is technically challenging due to several core issues related to data sensitivity, interoperability, authentication, and trust management. One of the primary challenges lies in ensuring data anonymization while preserving enough context to make shared intelligence useful. Stripping PII or proprietary system data from logs and indicators of compromise (“IOCs”) without losing forensic value is difficult, especially when threat data is tightly coupled with network environments or user activity. Another major obstacle is the lack of interoperability between different organizations'threat detection systems, security information and event management (“SIEM”) tools, and data formats. Without common standards, shared information may be incompatible or require extensive manual translation, reducing its timeliness and utility. Additionally, secure identity and access management is a technical hurdle—ensuring that only vetted, authorized entities can contribute to or receive threat intelligence without risking leaks, manipulation, or exposure to bad actors. Existing platforms often fall short in providing strong encryption, audit trails, and tamper-proof sharing, all of which are essential to maintain confidentiality and trust. Furthermore, many threat-sharing mechanisms rely on centralized infrastructures, which introduce single points of failure and governance disputes. These technical limitations, combined with legal and operational complexity, make it difficult to build robust, scalable, and widely adopted systems that foster secure, anonymous collaboration across organizations.

### SUMMARY

In view of these technical challenges, systems and methods are described herein for knowledgeless data profiles for real-time detection and sanitized sharing of information about potentially illicit activities prior to the activities infiltrating legitimate financial systems. For example, knowledgeless data profiles—constructed using advanced cryptographic techniques such as secure multi-party computation, homomorphic encryption, and private set intersection—offer a powerful solution to the technical challenges of creating standardized mechanisms or trusted forums for sharing threat intelligence safely. These profiles encapsulate key attributes or patterns of user or system behavior in a format that is non-revealing, meaning the underlying sensitive data remains fully hidden during comparison or validation. By enabling entities to verify, match, or correlate threat-related information (such as indicators of compromise, user behavior anomalies, or attack signatures) without exposing the raw data, knowledgeless profiles eliminate many of the trust and privacy concerns that have historically hindered collaboration. For example, two organizations could determine whether they are being targeted by the same actor or malware strain by comparing encrypted behavioral fingerprints without revealing employee activity logs, infrastructure specifics, or client data. This approach also supports interoperability, as cryptographic protocols can be standardized across platforms, making it easier for different organizations and tools to participate in threat-sharing frameworks without needing to fully trust each other or a central authority. Additionally, knowledgeless profiles reduce the risk of data leakage and misuse, addressing key legal and compliance barriers. As a result, they offer a path toward scalable, secure, and privacy-preserving collaboration, allowing industry entities to participate in shared cyber defense efforts without compromising proprietary or personal information.

However, enabling privacy-preserving collaboration through the use of knowledgeless data profiles, raises another novel technical challenge, specifically, how to determine who (e.g., which of the knowledgeless data profiles) to facilitate collaboration between at any given time. One approach is to simply facilitate collaboration between all active users. However, not only does this risk exposing the collaboration to unauthorized parties (e.g., masked as a legitimate active user), but this also exponentially increases the computation resources needed for collaboration as comparing and/or validating knowledgeless data profiles between even two users is computationally taxing due to the need to deal with the advanced cryptographic techniques.

Accordingly, in view of this novel technical challenge, the systems and methods may in some embodiments use dynamic clustering of users based on tokens in real-time queries. For example, in response to receiving a query related to an illicit activity, the system may detect tokens in the query (e.g., the type of activity, potential targets, geographic areas affected, etc.). The system may then compare these tokens to indicia from the knowledgeless data profiles. By doing so, the system may determine the specific users (or knowledgeless data profiles) to facilitate collaboration between. Moreover, the system may continue to monitor responses from collaborating users for any information that may compromise proprietary or personal information. While such censorship may, in conventional instances, reduce the value of the collaboration (e.g., obscuring responses to the point at which the response is no longer useful), the system may limit the censorship to data determined to be proprietary or personal information based on the users'knowledgeless data profiles. Thus, maximizing the relevance of responses while mitigating potential for data leakage and/or misuse.

In some aspects, systems and methods for using knowledgeless data profiles for real-time detection and sanitized communications are described. For example, the system may receive a first communication in an encrypted, multi-user platform, wherein the first communication comprises a first query relating to a first incident. The system may parse the first communication to determine a first token describing the first incident. The system may retrieve a first knowledgeless data profile, wherein the first knowledgeless data profile comprises a first privacy-preserving, cryptographically encoded representation of a first user. The system may retrieve a second knowledgeless data profile, wherein the second knowledgeless data profile comprises a second privacy-preserving, cryptographically encoded representation of a second user. The system may determine that the first token corresponds to a first indicium of the first knowledgeless data profile, wherein the first indicium represents a first portion of the first privacy-preserving, cryptographically encoded representation. The system may determine that the first token corresponds to a second indicium of the second knowledgeless data profile, wherein the second indicium represents a second portion of the second privacy-preserving, cryptographically encoded representation. The system may, in response to determining that the first token corresponds to the first indicium and the second indicium, generate a first group comprising the first user and the second user.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1A shows an illustrative user interface for monitoring activity facilitated by a computer network, in accordance with one or more embodiments.

FIG. 1B shows an illustrative mobile user interface for monitoring activity facilitated by a computer network, in accordance with one or more embodiments.

FIG. 2 shows an illustrative diagram of determining a token, in accordance with one or more embodiments.

FIG. 3 shows an illustrative diagram of matching knowledgeless data profiles, in accordance with one or more embodiments.

FIG. 4 shows illustrative components for a system used to facilitate the use of knowledgeless data profiles, in accordance with one or more embodiments.

FIG. 5 shows illustrative steps for using knowledgeless data profiles for real-time detection and sanitized communications, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

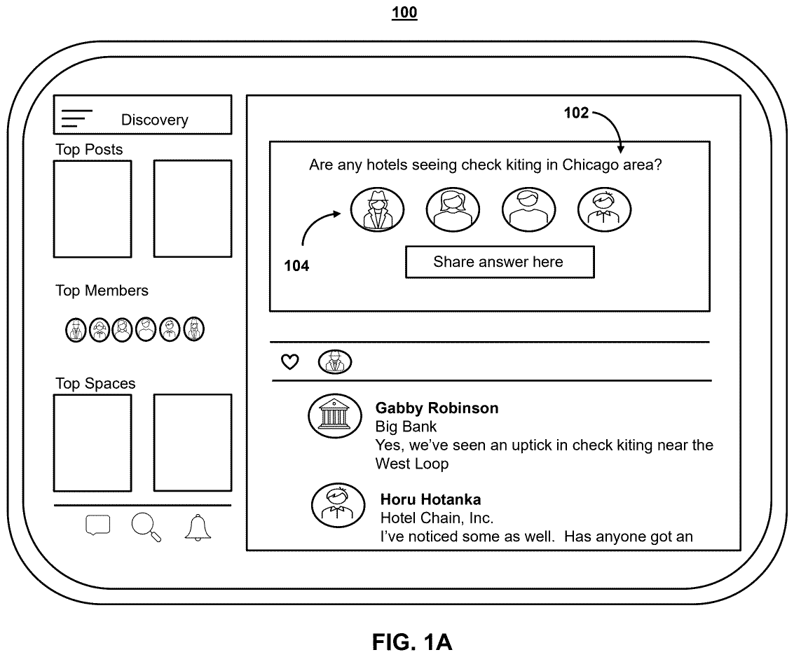

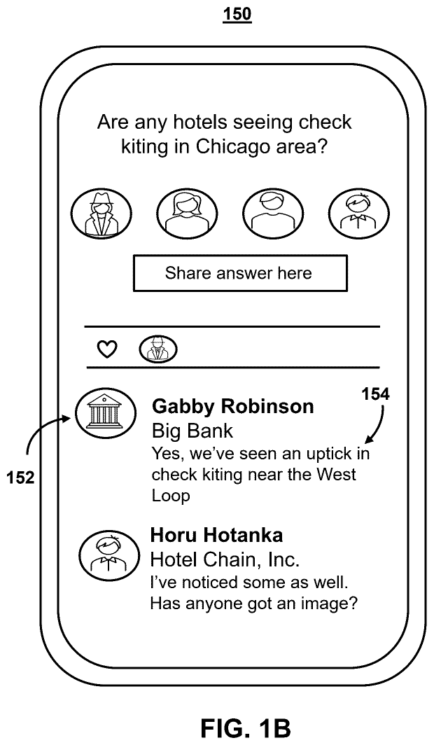

FIG. 1A shows an illustrative user interface for monitoring activity facilitated by a computer network, in accordance with one or more embodiments. For example, user interface 100 shows communication 102 being shared amongst a plurality of users (e.g., user 104). In some embodiments, user interface 100 may be designed to support an encrypted, multi-user communication platform—such as a privacy-preserving social media-style interface for cyber threat collaboration. For example, individual users, such as user 104, can initiate or respond to communications (e.g., communication 102), which may include messages, questions, and/or alerts posted to other vetted users on the platform. The system may facilitate secure, topic-driven interactions while safeguarding sensitive identities and information. It may be designed to serve as a cross-industry platform, allowing users from diverse sectors—such as finance, healthcare, travel, lodgings, critical infrastructure, and government—to share insights about cybersecurity incidents, online fraud, ransomware, phishing campaigns, and other electronic crimes.

The platform may be encrypted end-to-end, ensuring that communications are accessible only to authorized parties. The system may play an active role in intelligently matching users to others based on shared interests, geographic regions, active threat profiles, and incident classifications. For example, a user experiencing a phishing campaign targeting financial institutions in the Asia-Pacific region may be automatically linked to others who have observed similar attack patterns. The system performs automated vetting of users, possibly incorporating behavioral analytics, domain verification, or historical trust scores to ensure only credible individuals participate in sensitive discussions. Once users are matched or grouped, a human moderator may perform a manual review to validate legitimacy, particularly for high-risk threat discussions or classified industry topics.

Furthermore, the system may support hyper-targeting based on security breach types. For instance, if the platform identifies users involved in or observing activity related to credential stuffing attacks or supply chain compromises, it can dynamically cluster those users into secure topic-specific threads. These micro-communities enable real-time threat exchange, crowd-sourced intelligence, and collaborative mitigation planning—without disclosing raw logs, private systems, or organizational identities. In essence, this figure represents a secure, AI-assisted communication layer for proactive and privacy-respecting cyber threat intelligence sharing, empowering trusted users to collaborate without compromising operational security.

As described herein, activities facilitated by user interface 100 may comprise communications, transactions, and/or other exchanges. For example, activities may refer to any interaction, exchange, or transmission of data that occurs within a networked environment, whether digital or physical. These activities encompass a wide range of operations, including communications, such as emails, instant messaging, and VoIP calls; transactions, such as financial exchanges, cryptocurrency transfers, or database updates; and content exchanges, including file sharing, API requests, streaming, and data synchronization between systems. Network activities can be initiated by users, automated processes, or system protocols, and they often involve multiple layers of network infrastructure, such as routers, firewalls, and cloud servers. In cybersecurity and compliance contexts, monitoring network activities is crucial for detecting anomalies, preventing unauthorized access, and ensuring regulatory adherence. Whether occurring in corporate networks, public internet infrastructure, or decentralized systems, network activities serve as the backbone of modern digital operations, enabling real-time collaboration, commerce, and data-driven decision-making.

Activities may be based on any content. For example, content may refer to any form of information, data, or media that is created, shared, transmitted, or stored within a networked environment. Network activities can be based on various types of content, including text-based data, such as emails, documents, code, and logs; multimedia content, including images, videos, and audio files; structured data, such as database records, financial transactions, or metadata exchanged via APIs; and interactive content, like social media posts, live streams, or collaborative documents. Additionally, content can be categorized by its function within a network, such as communication-based content (e.g., chat messages, forum discussions), transactional content (e.g., purchase records, digital signatures), and sensor-generated content (e.g., IoT device logs, telemetry data). The nature of content influences how it is transmitted, stored, and secured, with different compliance and security measures applied based on sensitivity, ownership, and regulatory requirements. Whether static or dynamic, content serves as the core element driving network activity, shaping digital interactions, business operations, and information flows across various platforms.

In some embodiments, the system may enforce a content control rule related to content shared on the platform. For example, the content control rule may comprise regulatory and compliance rules about sharing private and/or personal information. In some embodiments, rules may refer to hardware, software, regulatory, and/or workflow procedures, rules, and/or guidelines for activities conducted by, and/or facilitated by, the entities. Content control rules may be encoding policies, protocols, and operational guidelines that govern how a user's hardware, software, and regulatory requirements interact to facilitate secure and efficient activities. These rules may define network access controls, data transmission policies, security enforcement mechanisms, and operational workflows, ensuring compliance with technical and regulatory standards. Hardware-based rules may dictate firewall settings, routing protocols, or VLAN segmentation to isolate sensitive financial data. Software-driven configurations may enforce encryption policies, API rate limits, and authentication protocols to protect financial transactions. Regulatory rules embed compliance frameworks such as PCI-DSS (for payment card security), GDPR (for data privacy), or FINRA (for financial market integrity) into network policies, ensuring that data storage and transaction flows meet legal requirements. Workflow procedures define automated responses, such as fraud detection triggers that flag suspicious transactions exceeding regulatory thresholds.

For example, in a financial institution, a rule may restrict information about customer names being distributed to only authorized banking servers, which are authenticated with multi-factor authentication. Similarly, a software-based policy may require real-time encryption of all communications data during transmission, ensuring compliance with messaging standards for secure international transactions. A workflow rule could define an approval hierarchy, ensuring that communications of a certain type require managerial review before execution. Collectively, these rules—embedded as structured content—govern and safeguard financial operations, ensuring security, compliance, and operational efficiency.

Rules may also enforce multi-factor authentication (MFA) policies, requiring biometric verification, one-time passcodes, or hardware security tokens for communications and/or collaboration. Encryption and secure tunneling protocols, such as TLS 1.3 and VPN access controls, ensure that transaction data is securely transmitted, reducing the risk of man-in-the-middle (MITM) attacks. Account access segmentation is another crucial rule, restricting network permissions based on role-based access control (RBAC), ensuring that only authorized personnel can approve or modify financial transactions.

To enhance cybersecurity and prevent unauthorized financial activities, governments may enforce strong encryption standards (e.g., AES-256, TLS 1.3) and require financial networks to maintain end-to-end encryption for all sensitive transactions. Access control policies, such as Zero Trust security models, mandate continuous verification of users and devices accessing financial systems, reducing risks associated with insider threats or credential theft. Geolocation-based transaction restrictions are another regulatory measure, ensuring that financial transactions involving sanctioned countries or politically exposed persons (PEPs) are blocked or flagged for review.

User 104 may comprise users, companies, groups, and/or regulatory bodies. For example, in some embodiments, user interface 100 may facilitate communications between two parties related to a recent transaction, while in other embodiments, user interface 100 may be used to monitor entities such as a financial institution and a regulatory body for the financial institution. For example, user interface 100 may generate recommendations and/or responses related to one or more incidents.

The platform may comprise a computer network, a distributed network, a cloud network, and/or an internal network for an entity. For example, a network may be a system of interconnected devices, entities, or nodes that facilitate the exchange of data, communications, and transactions across various infrastructures. Networks can take multiple forms depending on their architecture, purpose, and scope. A computer network consists of linked computing devices, such as servers, workstations, and IoT devices, enabling data transmission through wired or wireless connections. A distributed network extends across multiple locations, where computing resources are decentralized, allowing for scalability, fault tolerance, and high availability—commonly used in blockchain systems and peer-to-peer communications. A cloud network is a virtualized infrastructure hosted by cloud service providers, offering on-demand resources, scalable computing, and global accessibility for businesses and applications. An internal network is a private system used by an entity, such as a corporate intranet or secure financial transaction network, ensuring restricted access, regulatory compliance, and controlled data flows within an organization. Each type of network incorporates specific security, access control, and communication protocols to manage interactions efficiently while maintaining integrity, confidentiality, and reliability.

In some embodiments, the network may comprise a blockchain network. For example, a blockchain network may be a decentralized, distributed ledger system that records and verifies transactions across multiple nodes in a secure, transparent, and tamper-resistant manner. Unlike traditional centralized networks, where a single authority controls data and transactions, a blockchain network operates through a consensus mechanism (such as Proof of Work (PoW), Proof of Stake (PoS), or other variants) to validate and add new transactions to the ledger. Each transaction is grouped into a block, cryptographically linked to the previous block, forming an immutable chain of records. Blockchain networks can be public, where anyone can participate (e.g., Bitcoin, Ethereum), private, where access is restricted to authorized entities (e.g., enterprise blockchains like Hyperledger Fabric), or consortium-based, where multiple organizations share control over the network. These networks are widely used for cryptocurrency transactions, smart contracts, supply chain management, digital identity verification, and secure financial operations, providing enhanced security, transparency, and decentralization compared to traditional record-keeping systems.

In some embodiments, the system may aggregate information to generate data profiles based on data scraping, collecting, and/or monitoring. For example, data sources may comprise any origin and/or repository of information that can be accessed, extracted, and used for various purposes such as analysis, reporting, decision-making, or integration into other systems. These sources can take many forms, including structured databases, unstructured text files, web pages, application programming interfaces (APIs), logs, or real-time data streams. They can exist within local systems, cloud environments, or external platforms. Structured data sources, like relational databases, store information in organized tables with predefined schemas, making it easier to query and retrieve specific data. In contrast, unstructured data sources, such as emails, social media content, or multimedia files, require additional processing to extract useful insights. Data sources can also vary by accessibility and ownership, ranging from publicly available resources, such as government open data and publicly indexed web pages, to private and secured sources, such as enterprise databases or proprietary systems. Regardless of their format or location, data sources serve as the foundation for building analytical models, automating processes, and supporting operational or strategic objectives. Access to data sources often requires tools, protocols, or permissions to ensure proper integration and compliance with security and privacy standards.

FIG. 1B shows an illustrative mobile user interface for monitoring activity facilitated by a computer network, in accordance with one or more embodiments. For example, user interface 150 may receive data (e.g., query 156 and/or data from other data sources) and generate content (e.g., response 154) related to a user (e.g., user 152). For example, user interface 150 may serve as an interactive platform that facilitates personalized content generation for a user 152. The user interface 150 is shown receiving input data—specifically a query 156, which may represent a search, question, or request for insight from user 152. In addition to the direct query, the system may also ingest external data from other sources, such as user activity logs, profile information, historical interactions, or real-time feeds from enterprise or cloud-based data repositories. These additional data sources enrich the context of the user's query.

Upon receiving this input, the system may process the query using backend intelligence—potentially leveraging machine learning models, natural language processing, and domain-specific knowledge bases—to generate response 154. This response is personalized and context-aware, meaning it reflects not only the explicit request but also the implicit preferences or behaviors associated with user 152. The response could include recommendations, summaries, alerts, answers, or other dynamically generated content, depending on the system's design and the type of query.

This architecture may support use cases such as personalized threat intelligence dashboards, customer service agents, virtual assistants, or analytical platforms in enterprise environments. In some embodiments, user interface 150 may act as the central interaction point, intelligently mediating between user intent and data-driven insight to deliver highly relevant outputs without requiring the user to navigate raw data themselves.

As described herein, data may be a collection of raw facts, figures, or measurements that represent information about objects, events, or concepts. It serves as the foundational element for analysis, decision-making, and communication. Data can take various forms, including numerical values, textual descriptions, images, audio, or video. It can be structured, organized in a specific format like rows and columns in a database; semi-structured, such as JSON or XML files with tags but no strict schema; or unstructured, such as free-form text, social media posts, or multimedia content. The type of information included in data depends on its source and purpose. For example, transactional data may include timestamps, customer IDs, product details, and payment amounts. Demographic data could contain information such as age, gender, location, and income level. Scientific data might capture temperature readings, chemical compositions, or experimental results. Other examples include metadata, which provides information about other data (e.g., file creation date), and behavioral data, which tracks user interactions, clicks, or activity patterns. Regardless of its type, data is a critical resource for extracting insights, identifying trends, and enabling informed decisions.

In some embodiments, data may be incident data. Incident data may refer to the collection of information related to a specific event or occurrence—such as a cybercrime, fraud attempt, or other form of electronic crime—that may indicate a breach, anomaly, or malicious activity within a digital environment. This data is typically gathered from a plurality of sources, including network logs, user activity traces, system alerts, endpoint detection tools, email gateways, threat intelligence feeds, and third-party monitoring platforms. For example, in the case of a phishing attack, incident data might include the malicious email's metadata, sender IP address, payload attachments, user interaction logs, and DNS resolution records. In a fraud scenario, it may comprise transaction histories, geolocation mismatches, behavioral biometrics, and flagged user sessions. Incident data can also include contextual or descriptive metadata such as timestamps, device types, user roles, and application states at the time of the event. The purpose of incident data is to provide a comprehensive, multi-dimensional view of what occurred, when it occurred, and how it unfolded—enabling investigators, automated systems, or AI models to analyze, classify, and respond to the incident accurately and efficiently.

Data may be aggregated into data profiles by collecting and combining various pieces of information from multiple sources to create a comprehensive representation of an individual's or entity's behaviors, preferences, and attributes. This process begins with data acquisition, where relevant information—such as demographic details, transaction history, online activity, social media interactions, and location data—is gathered. These data points are then cleaned, normalized, and structured to ensure consistency and accuracy. The aggregated data may be analyzed to identify patterns and relationships, enabling the creation of a detailed profile. For instance, purchase history and browsing behavior can indicate preferences, while location data might reveal routines or frequently visited places. This information is typically categorized into attributes such as interests, habits, demographics, and predicted needs. Advanced techniques, such as machine learning algorithms, can further enrich profiles by deriving insights like predictive behaviors or segmenting users into groups based on similarities.

Data profiles may be used to identify known traffickers and individuals or entities involved in illicit activities by aggregating and analyzing data that reveals patterns, connections, and behaviors indicative of illegal operations. By compiling information from various sources—such as online activity, financial transactions, social media interactions, communication records, and public databases—profiles can highlight suspicious behavior or unusual patterns that align with known indicators of trafficking or other illicit activities. For instance, frequent transactions across multiple accounts, inconsistent travel patterns, or communications with flagged individuals can signal potential involvement in unlawful activities.

Advanced analytics tools and machine learning algorithms can enhance these profiles and/or other incident data by identifying correlations, trends, and anomalies that may not be immediately apparent. For example, network analysis can reveal relationships between entities, exposing hidden connections within trafficking networks. Behavioral profiling can flag activities such as unusual spending, frequent use of anonymizing tools, or participation in dark web marketplaces. Additionally, integrating external intelligence, such as law enforcement data or watchlists, can further refine profiles to match against known offenders or high-risk entities. These data profiles serve as critical tools for law enforcement, financial institutions, and regulatory bodies, enabling targeted investigations and proactive measures to disrupt criminal networks.

In some embodiments, the system may display aggregated data organized into a structured form that enables users to gain meaningful insights by presenting information in an accessible and interactive format, often through dashboards, tables, or visualizations. For example, when working with financial institutions, the system may ingest raw data from their account and transaction monitoring systems, including transaction details, customer profiles, and flagged activities. The system may then perform advanced data processing to cross-check this information against external data sources, such as business records, email logs, phone directories, or e-transaction handles. By aggregating these datasets, the system creates a detailed and interconnected view of entities involved in financial activities.

In some embodiments, the system may further generate one or more recommendations that describe probabilities (e.g., “risk scores”) for a given action (e.g., a type of illicit activity). For example, the system may populate user interface 150 by aggregating and organizing relevant data points—such as addresses, phone numbers, email addresses, and other identifying information—related to a given entity and displaying them in a structured and interactive format. This process begins with the system querying its data sources, which may include internal records, external databases, and real-time data feeds, to gather all associated information about the target entity. Once collected, the system analyzes and categorizes the data, linking it to related entities or transactions to build a comprehensive profile. User interface 150 may then present this information in a user-friendly format, such as tables, graphs, or network diagrams, allowing users to easily identify connections, trends, or anomalies within the data.

To provide deeper insights, the system employs advanced analytics to generate recommendations based on probabilities or “risk scores” that evaluate the likelihood of a given action or entity being involved in a specific type of illicit activity. These scores are calculated using machine learning models or rule-based algorithms that analyze patterns in the aggregated data. For instance, the system might assess factors such as transaction frequency, geographic anomalies, or links to high-risk entities and assign a risk score that indicates the probability of involvement in activities like money laundering or human trafficking. The recommendations, accompanied by visual indicators like heatmaps or color-coded alerts, guide users to focus on the most critical areas. By combining comprehensive data visualization with actionable risk assessments, the system enables users to make informed decisions and prioritize their investigative efforts effectively.

In some embodiments, the system may implement a color-matching or coding framework for classifying and sharing threat intelligence by embedding a standardized matching architecture designed specifically for knowledgeless data profiles. This approach enables real-time detection and sanitized sharing of information regarding potentially illicit activities before such activities have the opportunity to infiltrate legitimate financial systems. To do so, the system may provide the unification of the threat intelligence lexicon—defining a common set of identifiers, descriptors, and risk categories that allow institutions to speak a shared language when classifying bad actors or suspicious behaviors. This standardization eliminates ambiguity and improves consistency in how threats are understood and reported across different organizations.

To ensure uniformity in threat classification, the system may integrate a reference table and algorithmic model—essentially a standardized framework for matching and scoring threats. This framework enables each participating organization to identify and categorize suspicious profiles using the same logic and scoring thresholds, thereby aligning the way risk is interpreted across diverse systems. Color codes can serve as intuitive risk indicators—such as red for high-risk threats, yellow for medium-risk, and green for benign activity—allowing for quick triage and decision-making.

Moreover, the system facilitates streamlined information sharing by packaging threat intelligence in a normalized, structured format that can be seamlessly integrated into any partner's security infrastructure. By using standardized metadata fields and lightweight, sanitized data packets, the system ensures that no sensitive or identifying information is exposed, yet enough intelligence is preserved to make the data actionable. Additionally, cross-referencing capabilities can be enhanced through the use of common standards, allowing for automated correlation across multiple datasets. This improves the detection of emerging risks and facilitates the flagging of patterns that may indicate coordinated or evolving threats. Overall, this color-coded, standardized threat intelligence sharing framework provides a proactive, scalable method for defending financial systems from bad actors without compromising the privacy or security of the underlying data.

In some embodiments, the system can tie the color code to a risk score by implementing a tiered scoring model that quantifies the threat level of each entity or activity based on a predefined set of behavioral, contextual, and historical indicators. Each risk score would be derived from a weighted analysis of attributes such as the origin of the transaction, the velocity and frequency of activity, known associations with flagged entities, geolocation data, and anomaly patterns relative to a normative behavioral baseline. Once a numerical risk score is calculated—typically on a standardized scale, such as 0 to 100—it can be mapped to a corresponding color that visually communicates the urgency or severity of the threat.

For instance, scores from 0 to 30 could be coded green to indicate low risk, 31 to 70 could be yellow for moderate risk requiring further investigation, and 71 to 100 could be red to signal high-risk or urgent threats that warrant immediate mitigation. These color thresholds can be fine-tuned based on industry-specific needs or evolving threat landscapes, allowing the system to adapt without altering the core scoring logic. This color-coding mechanism offers a quick, intuitive way for analysts, automated systems, and partner organizations to interpret threat data, prioritize responses, and maintain a consistent understanding of risk across diverse operational environments. The mapping also allows for easy integration with dashboards, alerts, and machine-learning feedback loops, reinforcing a proactive and data-driven approach to threat detection and information sharing.

The system may allow users to interact with and view the color code through a user-friendly interface embedded within their existing platforms—such as customer onboarding portals, transaction monitoring systems, or case management dashboards. When users, such as hotel operators, financial institutions, or real estate and rental agencies, perform a search on a potential customer, transaction, or entity, the system may automatically evaluate the associated data against the threat intelligence framework and display a corresponding color-coded indicator. For example, if a user searches for a guest reservation or a financial transaction, the result may show a green, yellow, or red badge next to the name or activity, representing low, moderate, or high risk, respectively. This visual cue immediately informs the user of the underlying risk score and allows them to take context-appropriate action—such as flagging for further review, requesting additional documentation, or declining a transaction altogether.

The interface may also offer drill-down capabilities, allowing users to click on the color indicator to view a detailed breakdown of the risk score, including contributing factors, recent activity history, and cross-referenced data from shared threat intelligence sources. In more advanced deployments, users might also receive real-time alerts if a color status changes due to new intelligence, or if a newly entered profile matches a known high-risk pattern. Integration with existing workflows ensures that the color-coded insights are delivered without disrupting daily operations, enabling timely, informed decision-making. Additionally, administrative users could configure sensitivity thresholds for color assignments based on internal risk policies, making the system adaptable to varying regulatory and business requirements. This color-coded interface thus empowers a wide range of users to identify and respond to threats efficiently, even without technical expertise in cybersecurity or data analytics.

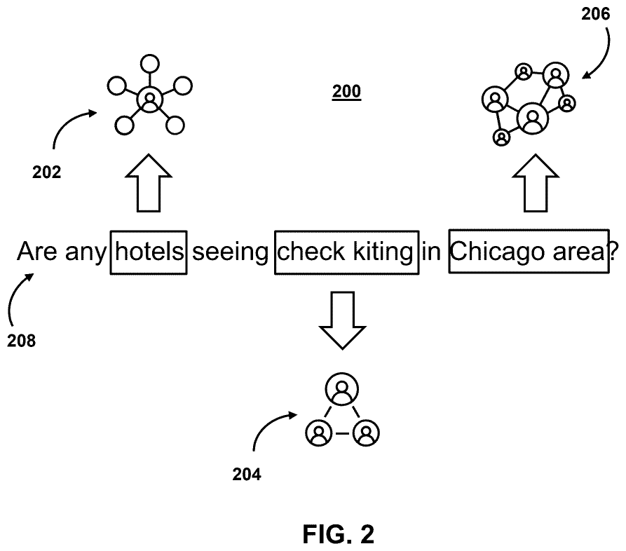

FIG. 2 shows an illustrative diagram of determining a token, in accordance with one or more embodiments. For example, as shown in diagram 200, the system may receive a first communication (e.g., communication 208) in an encrypted, multi-user platform, wherein the first communication comprises a first query relating to a cybersecurity incident. The system may parse the first communication to determine a first token describing the cybersecurity incident. For example, when a system receives a query such as “Are any hotels seeing check kiting in the Chicago area?”, it parses the input using natural language processing (NLP) techniques to extract meaningful entities and context. The system first identifies “hotels” as a reference to a specific industry domain, and uses this information to retrieve users and/or knowledgeless data profiles associated with hospitality-related organizations, companies, or operational environments. These may include fraud investigators, risk analysts, or cybersecurity personnel within the hotel industry. Next, the system parses “Chicago area” as a geographic identifier, matching it against metadata linked to user profiles, incident reports, or enterprise data records that are tagged with that location. This allows the system to localize its search and identify users or data sources geographically relevant to the inquiry. Finally, the phrase “check kiting” is recognized as a specific type of fraud-related incident. The system maps this term to its internal taxonomy of electronic crimes or financial fraud schemes and searches for users, incident logs, or knowledgeless data profiles that are either directly tagged with check kiting or demonstrate behavioral patterns associated with it. Through this combined parsing and mapping process, the system intelligently connects the query to relevant users, anonymized profiles, or historical data entries—enabling it to provide highly targeted insights or create a secure communication thread among vetted individuals who are positioned to share intelligence, collaborate on response strategies, or validate the presence of the specified incident in the defined industry and region.

In some embodiments, the NLP system extracts meaningful entities and context from a query by applying a combination of linguistic, statistical, and machine learning techniques designed to identify and interpret structured information within unstructured text. When a user submits a query like “Are any hotels seeing check kiting in the Chicago area?”, the NLP pipeline typically begins with tokenization, which breaks the sentence into individual words or phrases. Next, part-of-speech (POS) tagging assigns grammatical roles to each word (e.g., noun, verb, adjective), helping the system understand sentence structure. Named entity recognition (NER) is then applied to detect specific types of entities, such as “hotels” as an industry domain, “check kiting” as a fraud or crime type, and “Chicago” as a geographic location. These entities are matched against domain-specific ontologies or knowledge bases that allow the system to map terms to predefined categories.

In parallel, dependency parsing is used to analyze the relationships between words—such as understanding that “seeing” refers to hotels encountering check kiting activity, and that “in the Chicago area” modifies the location of the incident. Intent recognition models, often powered by deep learning or transformer-based architectures (like BERT or GPT), are used to infer the user's overall purpose—in this case, to find out if a specific type of fraud is affecting a certain industry within a given region. Additional context may be enriched through semantic similarity models that understand variations in phrasing and associate the query with known topics or event types. The result is a structured representation of the query, enabling the system to match it to relevant users, knowledgeless data profiles, or incident records with high precision.

The system generates tokens based on the parsing of the input text by applying a tokenization process, which divides the query into smaller units that can be analyzed and processed by downstream natural language understanding components. In many cases, each word in the input string—such as “are,” “any,” “hotels,” “seeing,” “check,” “kiting,” “in,” “the,” “Chicago,” and “area”—is treated as an individual token, allowing the system to analyze them independently or in sequence. However, more advanced systems use context-aware tokenization, where multi-word expressions that convey specific meaning together—like “check kiting” or “Chicago area” are treated as single composite tokens, because their combined meaning is different from the sum of their parts.

Additionally, the system may assign tokens not only based on literal words but also on semantic roles or contextual relevance. For example, the word “hotels” may be recognized as an industry token, “check kiting” as an incident type token, and “Chicago” as a geolocation token. These tokens are often enriched with metadata, such as entity type, source confidence score, or links to domain-specific taxonomies. In some systems, the entire text string can also be treated as a single token or embedding when passed into models that operate holistically, such as sentence encoders in transformer-based architectures. Ultimately, the granularity of tokenization—whether per word, phrase, or sentence—is dynamically chosen based on the NLP architecture and the analytical goals of the system, ensuring that each token preserves the context needed for accurate interpretation, matching, and response generation.

As shown in diagram 200, the system may retrieve knowledgeless data profiles based on the detected tokens. As described herein, a knowledgeless data profile may be a privacy-preserving, cryptographically encoded representation of a user, system, or event that can be compared or validated without revealing the underlying sensitive information. While the data profile may not “look like” traditional readable data (like a JSON object or plaintext log), it may exist in a mathematically transformed or encrypted format, making it useful for secure operations such as matching, classification, or verification.

In some embodiments, a knowledgeless data profile may be a cryptographically protected representation of any sensitive information—such as user behavior, identity attributes, or incident metadata—that is designed to enable comparison, classification, or validation without revealing the underlying raw data. Rather than containing readable text or identifiable values, a knowledgeless data profile may comprise transformed or encrypted features that preserve utility while eliminating exposure risk. Visually, it might appear as a set of hashed identifiers (e.g., SHA-256 hashes of email addresses or device IDs), encrypted feature vectors using homomorphic encryption (which allows computations on ciphertexts), or as probabilistic structures such as Bloom filters or secure tokens. For instance, behavioral metrics like login frequency, access patterns, or anomaly scores may be numerically encoded and encrypted, enabling threat models to detect suspicious patterns across systems without exposing individual records. In more advanced implementations, private set intersection techniques or zero-knowledge proofs may be used to show that a profile meets specific conditions (e.g., is part of a threat cluster) without disclosing which user or system it represents. Encryption methods vary by use case, but typically include symmetric encryption for secure storage, public-key encryption for secure sharing, or lattice-based schemes for privacy-preserving computation. As a result, a knowledgeless data profile looks unintelligible to a human viewer—often just a collection of encrypted strings or binary values—but is fully operable within privacy-respecting analytical systems, enabling secure collaboration and insight generation across organizations.

As shown in diagram 200, the system may group or cluster users and/or knowledgeless data profiles (e.g., group 202, group 204, and/or group 206) based on detected tokens by leveraging the semantic meaning and metadata associated with those tokens to identify shared attributes, behaviors, or contexts across profiles. As shown in diagram 200, each token may connect to a different group. For example, once a query or data input is parsed and tokenized—for example, extracting tokens such as “hotels,” “check kiting,” and “Chicago” the system maps these tokens to corresponding features within existing knowledgeless data profiles. Each profile, while encrypted or anonymized, contains structured indicators or metadata tags derived from original attributes (e.g., industry domain, incident type, geographic area) that align with these tokens. Using clustering algorithms such as k-means, hierarchical clustering, or more advanced graph-based techniques, the system can group profiles that share common tokens or have high semantic similarity in their encrypted or encoded feature vectors. For instance, profiles containing tokens related to the “hospitality industry” and the “Chicago area” may be grouped together to analyze regional attack trends, while those tagged with “check kiting” behavior may form a separate fraud-centric cluster. This clustering process is performed in a privacy-preserving way—without revealing the underlying sensitive details of the users or systems involved—and allows the system to generate actionable insights, surface emerging threat patterns, or connect vetted users with similar concerns, all based on the meaningful alignment of token-derived features across encrypted profiles.

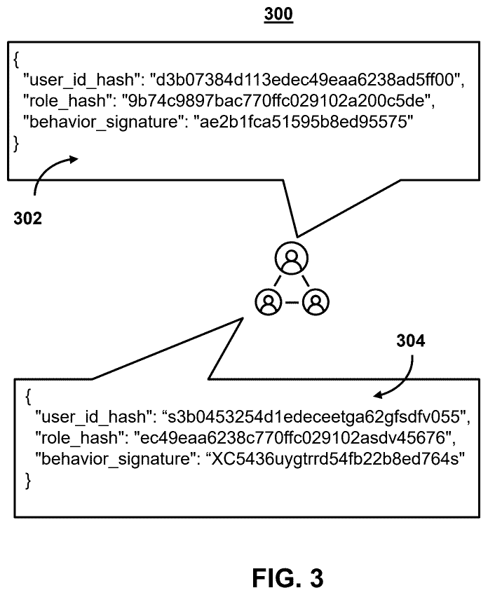

FIG. 3 shows an illustrative diagram of matching knowledgeless data profiles, in accordance with one or more embodiments. For example, diagram 300 may show knowledgeless data profile 302 and knowledgeless data profile 304. Without exposing any sensitive information, the system may compare data in knowledgeless data profile 302 and knowledgeless data profile 304.

For example, the system may retrieve knowledgeless data profile 302. Knowledgeless data profile 302 may comprise a first privacy-preserving, cryptographically encoded representation of a first user, wherein the first privacy-preserving, cryptographically encoded representation comprises a first plurality of indicia, and wherein each of the first plurality of indicia represents first respective portions of the first privacy-preserving, cryptographically encoded representation.

For example, the system may retrieve a knowledgeless data profile by querying a secure data store that holds privacy-preserving, cryptographically encoded representations of users or entities, typically indexed by non-sensitive metadata or encrypted identifiers. A knowledgeless data profile may comprise such a representation of a first user, where the profile is constructed in a way that conceals sensitive raw data while preserving structure and analytical value. This encoded representation includes a first plurality of indicia, which are discrete, recognizable features or signals derived from the original user data—transformed using cryptographic methods such as hashing, encryption, or differential privacy. Each indicia may correspond to a specific portion of the profile, which may represent behavioral patterns (e.g., login frequency, access time distribution), contextual attributes (e.g., industry, location, device type), or incident-related metadata (e.g., fraud types encountered, anomaly scores, or system interaction vectors). For instance, one indicium may represent an encrypted tokenized industry classification like “hospitality,” while another might correspond to an obfuscated geolocation such as the “Chicago area,” and a third could encode a behavioral anomaly signature related to “check kiting” fraud. These indicia enable the system to perform matching, clustering, or filtering across profiles without revealing underlying values. When a query or event prompts retrieval, the system uses tokenized or hashed selectors—derived from parsed input or model output—to search the profile database for matching indicia. This retrieval process supports secure analysis, allowing the system to identify relevant users or activity profiles while fully preserving privacy and data protection.

The system may also retrieve knowledgeless data profile 304. Knowledgeless data profile 304 may comprise a second privacy-preserving, cryptographically encoded representation of a second user, wherein the second privacy-preserving, cryptographically encoded representation comprises a second plurality of indicia, and wherein each of the second plurality of indicia represents first respective portions of the first privacy-preserving, cryptographically encoded representation.

For example, the system may perform comparisons by using transformed or encrypted representations of meaningful features, allowing analysis without revealing sensitive content. In the case of hashed attribute vectors (tokenized profiles), the system uses deterministic cryptographic hashes of identifiable attributes such as user ID, role, or behavioral patterns. Comparisons are done directly on these hashes—if two entities hash the same input using the same algorithm and key, the resulting hashes will match. For instance, two organizations may hash IP addresses involved in security incidents and identify common hashes, indicating a shared threat actor. The system compares values like hash(user_id), hash(role), or hash(ip_address).

With homomorphically encrypted vectors, the system uses encrypted numerical features derived from user activity, such as the number of logins, typing speed, or geolocation frequency. These encrypted values enable mathematical operations—such as similarity scoring or threshold comparisons—without decryption. Processing occurs entirely in the encrypted domain, with only the final result decrypted by authorized parties. Features like enc(#of logins), enc(location_entropy), and enc(failed_login_rate) are compared in this format.

In zero-knowledge proof (ZKP) statements, the system uses cryptographic proofs that confirm an attribute or group membership without revealing the actual value. For example, a user may prove they belong to a trusted group without disclosing their identity. The system validates the proof and compares the claim without accessing or comparing the underlying attribute directly.

What's compared is the cryptographic proof itself—such as ZKP(user ∈trusted_group)—which provides binary validation (true or false) without disclosure.

For private set intersection (PSI) tags, the system uses encrypted or obliviously hashed identifiers, such as malicious domains, suspicious email addresses, or known attacker accounts. Each organization encrypts its list and uses a PSI protocol to compute the intersection securely. The system compares encrypted values—enc(ioc_list_1) and enc(ioc_list_2)—and only learns the overlapping elements, without revealing non-matching data.

Finally, with differential privacy aggregates, the system uses noisy statistical summaries of population-level trends, such as average login frequency or entropy of location usage. These aggregates allow comparisons while protecting individual data points from inference. For example, the system may compare noisy_avg_login_frequency_orgA to noisy_avg_login_frequency_orgB to detect unusual deviations or alignments between organizations. The added noise ensures that individual behavior cannot be reverse-engineered.

In all these methods, the system may rely on mathematically protected representations—hashes, encrypted values, cryptographic proofs, and privacy-preserving aggregates—to compare information without accessing the underlying sensitive data. This enables secure collaboration, threat detection, and validation across organizations while maintaining strict confidentiality and user privacy.

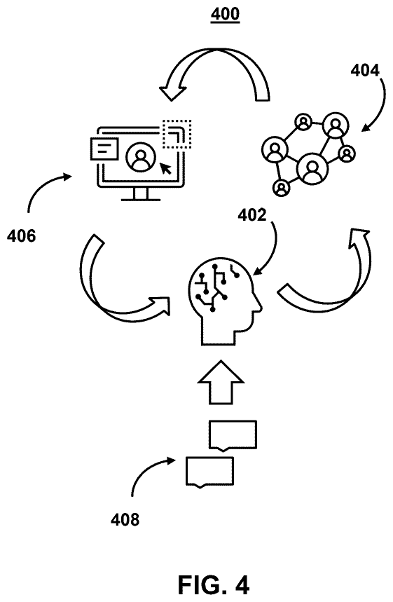

FIG. 4 shows illustrative components for a system used to facilitate the use of knowledgeless data profiles, in accordance with one or more embodiments. For example, FIG. 4 includes system 400. System 400 includes model 402. Model 402 may comprise a multiple component artificial intelligence model. Model 402 may comprise an architecture with multiple model components. For example, model 402 may include one or more RAG models. Model 402 may be built upon a large language model (e.g., model 408).

For example, a model (e.g., model 402) may refer to an artificial intelligence (AI) system that consists of multiple interconnected components designed to process data, generate insights, and support decision-making. Model 402 may incorporate an architecture with multiple model components, each specialized for different tasks, such as natural language processing (NLP), retrieval-augmented generation (RAG), anomaly detection, or predictive analytics. These components work together to enhance the model's ability to retrieve relevant data, generate accurate responses, and adapt to complex workflows.

In some implementations, model 402 may include one or more RAG models, which combine retrieval-based and generative AI techniques to improve response accuracy by fetching information from external knowledge bases before generating outputs. This allows model 402 to ground its responses in up-to-date, contextually relevant data rather than relying solely on pre-trained knowledge. Additionally, model 402 may be built upon a large language model (e.g., model 408), which serves as the foundational AI engine, leveraging deep learning techniques to understand, process, and generate human-like text. Model 408 provides linguistic and contextual understanding, while RAG components enhance retrieval-based reasoning and factual consistency.

The architecture of model 402 may also include specialized sub-models, such as risk assessment models for fraud detection, compliance models for regulatory adherence, sentiment analysis models for customer interactions, or reinforcement learning components for adaptive learning. By integrating these AI-driven components, model 402 can be tailored for diverse applications, such as financial auditing, cybersecurity monitoring, customer support automation, and workflow optimization. The modular design ensures that model 402 remains flexible, scalable, and capable of adapting to various industry requirements while maintaining accuracy, transparency, and efficiency in AI-driven decision-making.

Model 402 may generate outputs 404, which may include detected tokens, connected users and/or knowledgeless data profiles, and/or detected incidents. For example, a model (e.g., model 402) may generate outputs (e.g., outputs 404) by processing input data, applying its trained algorithms and architectures, and producing relevant responses, prompts, or recommendations based on predefined objectives. The model operates in multiple stages, beginning with data ingestion, where it receives structured or unstructured inputs, such as user queries, transaction logs, regulatory guidelines, or real-time network activities. It then processes this input through various AI components, which may include natural language processing (NLP) models, retrieval-augmented generation (RAG) models, predictive analytics, and rule-based engines.

If model 402 includes a RAG component, it first retrieves relevant context from external or internal knowledge bases before generating an output, ensuring factual accuracy and contextual grounding. If the model is built upon a large language model (LLM, e.g., model 408), it uses deep learning and probabilistic reasoning to construct human-like text responses. Outputs 404 can take various forms, including recommendations related to detected tokens, connected users and/or knowledgeless data profiles, and/or detected incidents.

For example, if model 402 is monitoring financial transactions and detects potential fraudulent activity, it may generate an output 404 in the form of a recommendation to flag the transaction for further review, suggest additional authentication steps, or notify compliance officers. Similarly, if a regulatory change is detected that affects an institution's compliance policies, model 402 may generate a prompt on a user interface, advising administrators to update internal policies or implement new security measures. By leveraging machine learning algorithms, domain-specific knowledge bases, and real-time data processing, model 402 dynamically adapts its outputs based on evolving conditions, ensuring accuracy, relevance, and alignment with hardware, software, regulatory, and workflow requirements. The model's ability to contextually analyze inputs and generate actionable outputs makes it a powerful tool for decision-making, risk mitigation, and operational efficiency across various domains.

Outputs 404 may be compared against label 406. Label 406 may comprise labels of known information (e.g., labeled information related to tokens, connected users and/or knowledgeless data profiles, and/or detected incidents, etc.) that may be used to train model 402 and/or provide feedback. For example, a model (e.g., model 402) can use its outputs (e.g., outputs 404) and labeled data (e.g., label 406) to train itself through a continuous learning process that involves supervised learning, reinforcement learning, and self-improving feedback loops. In this process, outputs 404—such as generated prompts, recommendations, or decisions—are compared against label 406, which consists of known, correct information, including labeled prompts, labeled recommendations, and verified ground-truth data. This comparison allows the system to evaluate the accuracy, relevance, and effectiveness of its outputs in real-world applications.

If an output deviates from the correct label, model 402 can adjust its internal weights, refine its decision-making logic, and update its predictive models using gradient-based optimization, loss function minimization, or reinforcement learning techniques. For example, if model 402 generates a group that differs from an expected group (as defined by label 406), the model can use this discrepancy as a learning signal to refine its reasoning process for future recommendations.

Additionally, the model can incorporate feedback mechanisms, where human experts or automated evaluators assess outputs 404 against label 406, providing explicit corrections or reinforcement signals. If the model uses a retrieval-augmented generation (RAG) framework, it can improve retrieval precision by learning which retrieved documents led to accurate outputs, reinforcing high-quality data sources over time. Similarly, in a reinforcement learning from human feedback (RLHF) paradigm, human reviewers can rank model responses, allowing the system to optimize for higher-quality outputs in subsequent iterations.

By continuously comparing its generated outputs to labeled data, model 402 can iteratively refine its language generation, decision-making accuracy, and compliance adherence, making it more adaptive, reliable, and contextually aware over time. This self-training process ensures that the model remains aligned with evolving tokens, users, knowledgeless data profiles, and/or detected incidents.

System 400 may be implemented through one or more electronic storage devices designed to electronically store information in various formats and media. These devices may utilize non-transitory storage and/or computer-readable media to retain data and can include both system storage, which is integrally provided within servers or client devices (e.g., substantially non-removable storage), and removable storage that can be connected to servers or client devices through interfaces such as USB ports, FireWire ports, or disk drives. Electronic storage media encompass a wide range of technologies, including optically readable storage media like optical disks, magnetically readable storage media such as magnetic tapes, hard drives, and floppy disks, as well as electrical charge-based storage media like EEPROM and RAM. Solid-state storage media, such as flash drives, are another common type of electronic storage. Additionally, virtual storage resources, including cloud storage, virtual private networks (VPNs), and other virtualized systems, are considered part of electronic storage. These devices are capable of storing various forms of data, including software algorithms, information processed or determined by processors, data obtained from servers or client devices, and other essential information that supports the functionality of various processes.

In some embodiments, system 400 and/or one or more components herein may be implemented using an application-specific integrated circuit. An integrated circuit may be a small electronic device made of semiconductor material, typically silicon, that contains a large number of microscopic electronic components such as transistors, resistors, capacitors, and diodes. These components are interconnected to perform a specific function or set of functions. Integrated circuits can be classified into various types based on their functionality, such as analog, digital, and mixed-signal ICs. The transistors within an IC are the primary building blocks, as they act as switches or amplifiers for electronic signals. The other components, like resistors and capacitors, are used for controlling voltage, current, and timing within the circuit. System 400 may design the integrated circuit to be application specific such that the design of the circuit is customized for a given application. In some embodiments, system 400 may use an integrated circuit system where one or more integrated circuits are spread throughout a system, network, and/or one or more devices. In such a case, the system design may ensure that the circuits are integrated with other electronic components like connectors, power supplies, and sensors to form a complete and functional electronic system. This integration allows for the implementation of sophisticated tasks in devices needed for one or more specified applications.

System 400 may comprise one or more devices such as a CPU, or Central Processing Unit, which may be the primary component of a computer responsible for executing instructions and performing computations necessary for various processes and functions. The CPU may interpret and execute instructions from programs and operating systems through a cycle of fetching, decoding, and executing commands. This cycle begins with the CPU retrieving an instruction from the system's memory, followed by decoding it to understand the required operation and finally executing it by performing arithmetic, logical, control, or input/output tasks. The CPU relies on its internal components, including the arithmetic logic unit (ALU) for mathematical operations, the control unit (CU) for directing data flow, and registers for temporary data storage. By leveraging its clock speed and multiple cores in modern processors, the CPU can execute complex processes efficiently, enabling the functionality of applications and systems.

Output 404 may represent the result of processing data or executing instructions. In the case of a CPU, outputs can include processed data, computational results, or responses to input commands. For models, outputs often consist of predictions, classifications, decisions, or other data derived from the model's algorithms or trained parameters. Once generated, the output is typically stored in a suitable storage medium, such as system memory (RAM), a local storage device (e.g., hard drive or SSD), or a networked storage system. This stored output can then be used in various ways depending on the application. For example, it might be displayed to users as visual or textual information, serve as input for subsequent computational tasks, or be transmitted to other devices or systems for further processing. The efficient storage and utilization of outputs are essential for enabling real-time responsiveness, supporting iterative processes, and ensuring seamless integration with larger workflows or systems.

In some embodiments, system 400 may use an I/O (Input/Output) path between devices, which may refer to the communication pathway that facilitates the exchange of data between computing devices or systems. An I/O path may encompass a variety of communication networks such as the Internet, mobile phone networks, mobile voice or data networks like 5G or LTE, cable networks, public switched telephone networks (PSTN), or combinations of these. These networks provide the infrastructure for transmitting data across different mediums. The I/O path can also include specific communication paths, such as satellite links, fiber-optic connections, cable connections, Internet-based communication paths (e.g., IPTV), and free-space links that support wireless or broadcast signals. In addition to external communication networks, computing devices may feature internal communication paths that integrate hardware, software, and firmware components. For example, multiple computing devices can operate as part of a unified cloud-based platform, leveraging interconnected communication paths to function collectively. These I/O paths are essential for ensuring seamless data flow, supporting applications, and enabling distributed computing environments.

In some embodiments, system 400 may be a cloud system. A system structured as a cloud system is designed to provide scalable, on-demand access to computing resources and services over the Internet or other networks. In a cloud system, multiple interconnected servers, data centers, and storage devices work together to deliver virtualized computing power, storage, and applications. These resources are hosted remotely in distributed locations, creating a virtualized environment that can dynamically allocate resources based on user demands. The cloud system is typically organized into three main service models: Infrastructure as a Service (IaaS), which offers virtualized hardware and network resources; Platform as a Service (PaaS), which provides tools and frameworks for application development; and Software as a Service (SaaS), which delivers software applications to users. The system relies on communication paths, including high-speed fiber-optic networks, satellite links, and wireless connections, to enable seamless interaction between users and the cloud infrastructure. Advanced management tools and load-balancing mechanisms ensure reliability, efficiency, and fault tolerance within the system. This structure allows users to access computing resources flexibly and cost-effectively without the need to maintain physical hardware.

In some embodiments, system 400 may use one or more APIs. An API, or Application Programming Interface, is a set of rules and protocols that allows different components within a system, such as system 400, to communicate and interact seamlessly. APIs define how software applications, services, or devices can request and exchange data, enabling interoperability between components regardless of their underlying technologies. Within a system, an API acts as a bridge between different modules, such as databases, user interfaces, or external services, facilitating the flow of information and the execution of commands.

For instance, in system 400, an API might enable device 410, a data storage component, to provide information to model 402, a processing unit. Model 402 could use the API to request specific data, execute operations, or send processed results back to another component. The API specifies the format and structure of the requests and responses, such as using JSON or XML, and enforces security protocols like authentication tokens or encryption to ensure secure communication.

APIs can also enable external systems to interact with system 400. For example, a financial application could use an API to query account balances, initiate transactions, or retrieve fraud detection reports generated by a model housed within the system. By standardizing interactions, APIs simplify the integration of diverse components, improve scalability, and support modular system designs, making it easier to expand or update individual parts without disrupting the entire system.

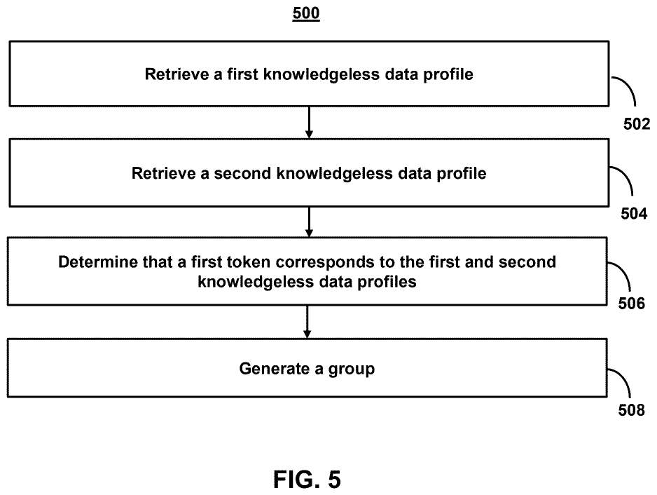

FIG. 5 shows illustrative steps for using knowledgeless data profiles for real-time detection and sanitized communications, in accordance with one or more embodiments. For example, the system may use process 500 (e.g., as implemented on one or more system components described above) to use knowledgeless data profiles for real-time detection and sanitized communications. For example, the system may receive a first communication in an encrypted, multi-user platform, wherein the first communication comprises a first query relating to a first incident and parse the first communication to determine a first token describing the first incident. For example, the system may operate within an encrypted, multi-user platform may receive a first communication—such as a message or inquiry—from a user, where the communication includes a first query related to a first incident, such as a cyberattack, fraud event, or other electronic crime. The communication is received through a secure, encrypted channel that ensures the content remains confidential and accessible only to authorized system components.

In some embodiments, the system may receive the first communication by receiving incident data from a plurality of sources, generating a feature input for a first model based on the incident data, wherein the first model is trained to identify potential incidents based on the incident data, inputting the feature input into the first model to generate a first output, and generating the first query based on the first output. For example, the system may receive the first communication by initiating a multi-stage process that begins with the collection of incident data from a plurality of sources, such as intrusion detection systems, endpoint monitoring tools, firewall logs, transaction records, user activity logs, and external threat intelligence feeds. This raw incident data is then aggregated and preprocessed to extract relevant attributes—such as IP addresses, user identifiers, access patterns, timestamps, geographic markers, or detected anomalies—and encoded into a structured feature input that conforms to the input requirements of a first model. This model is pre-trained or fine-tuned to identify potential incidents based on patterns and correlations within the incident data. Once the feature input is constructed, the system inputs the feature input into the first model, which processes the data and generates a first output. This output may include a classification (e.g., phishing, account takeover, or check kiting), a confidence score, and associated metadata indicating the likelihood, severity, and scope of the potential incident. Using this model-generated output, the system then generates the first query, which is formatted as a natural-language communication intended for distribution within the encrypted, multi-user platform. For example, if the output suggests a high likelihood of coordinated credential stuffing attacks targeting financial institutions, the system may construct a query such as, “Are any banks experiencing spikes in login failures from new IP ranges?” This query becomes the first communication, which the system can broadcast or route to relevant users or communities for collaborative threat validation and response.

In some embodiments, the system may receive the first communication by receiving a plurality of indicia corresponding to a plurality of users, generating a feature input for a first model based on the first token and the plurality of indicia, wherein the first model is trained to identify likelihood of users corresponding to inputted tokens, inputting the feature input into the first model to generate a first output, wherein the first output comprises a first likelihood that the first user corresponds to the first token, comparing the first likelihood to a threshold likelihood, and determining to retrieve the first knowledgeless data profile based on comparing the first likelihood to the threshold likelihood. For example, the system may receive the first communication by leveraging a process that integrates user-related signals and contextual incident tokens to identify relevant participants in an encrypted, multi-user platform. Initially, the system collects a plurality of indicia corresponding to a plurality of users. These indicia are privacy-preserving, cryptographically encoded representations of user characteristics—such as industry, geographic region, behavioral patterns, historical incidents, or interaction metadata. Simultaneously, the system parses the incoming communication to extract a first token that describes a specific incident or topic of interest (e.g., “account takeover” or “check kiting”). The system then generates a feature input by combining this token with the collected indicia, encoding the relationship between the incident context and each user's encrypted attributes. This feature input is passed to a first model that has been trained to assess the likelihood that a given user corresponds to a particular token, meaning the user is likely involved in or affected by incidents matching that category. Upon inputting the feature input into the model, the system generates a first output comprising a first likelihood score, which estimates how strongly a specific user—such as user 104 (FIG. 1A)—is associated with the incident represented by the token. The system then compares the first likelihood to a predefined threshold likelihood. If the likelihood exceeds the threshold, indicating a meaningful connection between the user and the incident type, the system proceeds to retrieve the first knowledgeless data profile corresponding to the user. This profile, which remains privacy-preserving, may then be used to further assess situational risk, match users for collaboration, or refine downstream content—such as targeted queries, alerts, or discussion threads—without compromising sensitive information.

In some embodiments, the system may parse the first communication to determine the first token describing the first incident by determining first text in the first query, determining second text in the first query, inputting the first text and the second text into a large language model to determine a first context of the first query, and determining the first token based on the first context. For example, upon receipt, the system may parse the content using NLP techniques to extract key components of the message. This parsing process may involve steps such as tokenization, part-of-speech tagging, and named entity recognition, enabling the system to break the text into structured elements. The system identifies the first query within the communication—e.g., “Has anyone seen account takeover attempts linked to new phishing domains?”—and analyzes the sentence to detect meaningful tokens. The system may determine a first token that describes the first incident, such as “account takeover” or “phishing domain.” This token is mapped to a predefined incident taxonomy or knowledge base, allowing the system to classify and interpret the context of the incident without exposing sensitive details. The identified token can then be used for downstream processes, such as retrieving relevant knowledgeless data profiles, clustering related incidents, or connecting users with similar experiences, all while maintaining data security and user privacy within the encrypted platform.

At step 502, process 500 (e.g., using one or more components described above) retrieves a first knowledgeless data profile. For example, the system may retrieve a first knowledgeless data profile, wherein the first knowledgeless data profile comprises a first privacy-preserving, cryptographically encoded representation of a first user. For example, the system may retrieve a first knowledgeless data profile by querying a secure, privacy-preserving database that stores cryptographically encoded representations of users, each designed to support analysis and matching without exposing sensitive information. The first knowledgeless data profile represents a specific user—referred to as the first user—but unlike traditional user profiles, it does not contain raw or identifiable data. Instead, it comprises a privacy-preserving, cryptographically encoded representation that has been generated using techniques such as secure hashing, homomorphic encryption, differential privacy, or zero-knowledge proofs. These methods transform the user's behavioral indicators, incident associations, domain affiliations, and contextual metadata into encoded tokens or feature vectors that can be queried and compared while remaining unintelligible to unauthorized systems or observers. The system identifies the profile to retrieve by matching encrypted selectors—such as hashed industry identifiers, encrypted behavioral traits, or incident-related tokens—against indexable elements within the database. Once a match is found, the system retrieves the corresponding encoded profile, which can then be used for downstream processing—such as clustering users, evaluating risk, or generating targeted communications—without revealing any underlying personal or organizational data associated with the user. This retrieval process ensures the system maintains strict confidentiality and data protection while still enabling intelligent, context-aware operations across users and incident types.

In some embodiments, the system may retrieve the first knowledgeless data profile by receiving the first privacy-preserving, cryptographically encoded representation, validating the first privacy-preserving, cryptographically encoded representation, and determining to generate the first knowledgeless data profile based on validating the first privacy-preserving, cryptographically encoded representation. For example, the system may retrieve the first knowledgeless data profile by first receiving a first privacy-preserving, cryptographically encoded representation associated with a user or entity. This representation may be submitted directly by a secure source—such as a trusted user device, a federated node, or a partner system—or it may be accessed from a privacy-preserving database. Upon receiving this encoded representation, the system performs a validation process to ensure the data is authentic, unaltered, and generated using approved cryptographic methods. This validation may involve verifying digital signatures, checking proof-of-origin metadata, or confirming that the representation adheres to a known encoding schema (e.g., homomorphic encryption structure, hashed token format, or zero-knowledge proof compliance). If the validation is successful—meaning the system determines the encoded representation is trustworthy and structurally valid—it proceeds to generate the first knowledgeless data profile. This profile is constructed by mapping the validated representation into a structured, machine-readable format that can be indexed, compared, and processed for further analysis. The resulting knowledgeless data profile may include feature vectors, encrypted behavioral markers, or other tokenized indicia that reflect the user's risk posture, incident relevance, or contextual attributes, all without exposing raw personal or organizational data. This approach enables the system to retrieve and use profiles securely, supporting privacy-preserving collaboration, threat detection, or user engagement within encrypted platforms.

At step 504, process 500 (e.g., using one or more components described above) retrieves a second knowledgeless data profile. For example, the system may retrieve a second knowledgeless data profile, wherein the second knowledgeless data profile comprises a second privacy-preserving, cryptographically encoded representation of a second user.

At step 506, process 500 (e.g., using one or more components described above) determines that a first token corresponds to the first and second knowledgeless data profiles. For example, the system may determine that the first token corresponds to a first indicium of the first knowledgeless data profile, wherein the first indicium represents a first portion of the first privacy-preserving, cryptographically encoded representation. Additionally or alternatively, the system may determine that the first token corresponds to a second indicium of the second knowledgeless data profile, wherein the second indicium represents a second portion of the second privacy-preserving, cryptographically encoded representation. That is, the system may determine that a first token corresponds to one or more of the first plurality of indicia and the second plurality of indicia.

For example, the system may determine that a first token corresponds to both a first and second knowledgeless data profile by analyzing whether the token maps to specific encoded elements—called indicia—within each profile's cryptographically protected structure. Each knowledgeless data profile consists of a plurality of indicia, with each indicium representing a different encoded attribute or behavioral signal derived from the underlying user data. For example, the system may determine that the first token, such as “check kiting,” corresponds to a first indicium within the first knowledgeless data profile, where that indicium encodes a fraud-related behavioral pattern or incident association and represents a first portion of the user's overall privacy-preserving representation. Simultaneously or alternatively, the system may identify that the same first token also matches a second indicium within a second knowledgeless data profile, where that indicium represents a second portion of the encoded data—such as a geographic correlation, industry involvement, or historical flag for related activity.

This mapping may be performed through cryptographic or probabilistic matching techniques, enabling the system to detect meaningful overlaps between tokens and indicia without decrypting or exposing the original content. The system may use secure index structures, hashed token matchers, or homomorphically processed filters to assess whether a token aligns with one or more indicia across multiple profiles. If such correspondences are found, the system concludes that the first token corresponds to one or more of the indicia in both the first and second profiles, allowing the system to cluster, flag, or surface these profiles for further analysis or communication—such as alerting relevant users, suggesting collaboration, or identifying coordinated threats—while maintaining strict adherence to privacy and data protection requirements.

In some embodiments, the system may determine that the first token corresponds to the first indicium of the first knowledgeless data profile by determining a first characteristic corresponding to the first token, selecting the first indicium, from a plurality of indicia from the first knowledgeless data profile, based on the first indicium corresponding to the first characteristic, and comparing the first characteristic to the first indicium. For example, the system may determine that a first token corresponds to a first indicium of a first knowledgeless data profile by following a structured comparison process based on shared characteristics. Initially, the system identifies a first characteristic associated with the first token—this characteristic may represent an encoded concept such as a fraud type, geographic tag, industry classification, or behavioral pattern. For example, if the token is “check kiting,” the corresponding characteristic might relate to financial fraud behaviors or transaction anomalies. The system then evaluates the first knowledgeless data profile, which includes a plurality of indicia, each representing a cryptographically encoded portion of the user's profile, such as behavioral data, domain affiliations, or prior incident associations.

From this set of indicia, the system selects a first indicium that is most likely to correspond to the first characteristic. This selection may rely on structural patterns, metadata associations, or cryptographic indexing that links each indicium to a specific type of encoded attribute. Once the candidate indicium is selected, the system compares the first characteristic to the selected first indicium using privacy-preserving comparison techniques—such as hash matching, encrypted similarity scoring, or homomorphic equality tests. If the comparison yields a valid match or exceeds a relevance threshold, the system concludes that the first token corresponds to the first indicium, and by extension, that the knowledgeless data profile is relevant to the query or incident represented by the token. This method enables the system to semantically link user profiles to emerging threat contexts while preserving data confidentiality.

In some embodiments, the system may determine that the first token corresponds to the first indicium of the first knowledgeless data profile by determining a first geographic region corresponding to the first token and determining that the first indicium corresponds to the first geographic region. For example, the system may determine that a first token corresponds to a first indicium of a first knowledgeless data profile by analyzing geographic alignment between the token's context and the encoded attributes of the profile. To begin, the system parses the token—such as one derived from a user query or incident report—and determines a first geographic region associated with that token. For example, if the token includes references like “Chicago” or “Midwest,” the system resolves this into a standardized geographic identifier. It then accesses the first knowledgeless data profile, which contains a plurality of indicia, each representing an encrypted portion of the user's contextual or behavioral footprint, including regional affiliations encoded through privacy-preserving methods like hashed location identifiers or homomorphic encryption. The system scans these indicia to determine whether any correspond to the identified first geographic region. This determination may involve checking encrypted geolocation codes, evaluating region-based tags derived from activity logs, or applying secure comparison functions that validate regional matches without decrypting the data. If the first indicium within the knowledgeless profile is found to encode or reference the same geographic region as the one associated with the token, the system infers that there is a contextual match. As a result, it concludes that the first token corresponds to the first indicium and that the associated knowledgeless profile is relevant to the geographic scope of the inquiry or incident. This enables the system to connect users or data profiles based on location-specific threat activity, while maintaining full privacy protections.

In some embodiments, the system may determine that the first token corresponds to the first indicium of the first knowledgeless data profile by determining a first cybersecurity incident type corresponding to the first token and determining that the first indicium corresponds to the first cybersecurity incident type. For example, the system may determine that a first token corresponds to a first indicium of a first knowledgeless data profile by identifying a shared association with a specific cybersecurity incident type. The process begins by analyzing the first token—such as a keyword or phrase extracted from a query or communication—to determine its semantic relevance to a known cybersecurity incident type, such as “phishing,” “ransomware,” “data exfiltration,” or “credential stuffing.” This determination may be made by matching the token to a predefined taxonomy or threat intelligence database that maps linguistic expressions to categorized threat types. Once the system identifies the first cybersecurity incident type associated with the token, it accesses the first knowledgeless data profile, which is composed of a plurality of privacy-preserving indicia, each representing encrypted, encoded attributes of a user or system. The system then examines the indicia within the profile to determine if any of them encode a connection to the same incident type. This may involve checking cryptographically hashed incident labels, evaluating similarity between encrypted behavioral signatures, or performing privacy-preserving comparisons using homomorphic techniques or secure multi-party computation. If the system identifies that the first indicium within the knowledgeless profile corresponds to the same cybersecurity incident type as the one determined from the token, it concludes that the token and indicium are contextually linked. As a result, the system infers that the first token corresponds to the first indicium, establishing the relevance of the knowledgeless data profile to the incident type in question. This linkage allows the system to match user profiles to specific types of threat activity without exposing sensitive operational data, enabling secure collaboration and targeted response.

In some embodiments, the system may determine that the first token corresponds to the first indicium of the first knowledgeless data profile by determining a first targeted entity corresponding to the first token and determining that the first indicium corresponds to the first targeted entity. For example, the system may determine that a first token corresponds to a first indicium of a first knowledgeless data profile by identifying a shared relationship to a specific targeted entity. The process begins by parsing the first token—typically extracted from a user query, incident report, or communication—to identify whether it references or implies a first targeted entity, such as a particular sector (e.g., “hospitals”), organization type (e.g., “banks”), or even a class of users (e.g., “executives” or “system administrators”). This interpretation may be derived through natural language processing and mapped against a known taxonomy of common cyber targets. Once the first targeted entity is identified, the system examines the first knowledgeless data profile, which includes a plurality of indicia, each representing an encrypted or otherwise privacy-preserving portion of the user's profile. These indicia may include encoded information about the user's organization, role, industry, or infrastructure exposure. The system evaluates whether any indicium matches the characteristics of the targeted entity determined from the token. This may be accomplished through secure comparison techniques such as homomorphic matching, hashed label correlation, or encrypted category filters. If the system determines that the first indicium corresponds to the same targeted entity—meaning that the user or entity represented by the knowledgeless data profile falls within the scope of the token's targeting context—it concludes that the first token corresponds to the first indicium. This enables the system to link user profiles to threat intelligence based on targeting patterns, without exposing identities or sensitive organizational data, and facilitates secure coordination or alerting within relevant communities.

In some embodiments, the system may determine that the first token corresponds to the first indicium of the first knowledgeless data profile by determining a first cryptographic hash corresponding to the first portion, determining a second cryptographic hash corresponding to text in the first query, determining the first indicium based on the first cryptographic hash, determining the first token based on the second cryptographic hash, and comparing the first token to the first indicium. For example, the system may determine that a first token corresponds to a first indicium of a first knowledgeless data profile by using cryptographic hashing to securely compare semantic or structural components without exposing the underlying data. The process begins with the system identifying a first portion of the knowledgeless data profile—such as an encoded representation of a user's role, incident history, or organizational attribute—and computing a first cryptographic hash of that portion using a secure, deterministic hashing function (e.g., SHA-256 or HMAC with a shared secret). This hash becomes the basis for identifying or retrieving the first indicium, which is a privacy-preserving, fixed-length representation of that encrypted profile element. In parallel, the system analyzes the first query—such as a user-submitted question or communication—and selects relevant text from the query that may correspond to a threat, industry, entity, or incident (e.g., the phrase “phishing attack on banks”). From this selected text, the system generates a second cryptographic hash using the same hashing function, ensuring compatibility for secure comparison. The first token is then derived or associated with this second hash, serving as the query-side equivalent of the indicium. To establish correspondence, the system compares the first token to the first indicium by checking whether the second hash matches the first hash. If a match is found, it indicates that the hashed text from the query semantically or structurally aligns with the hashed portion of the user's knowledgeless data profile. Since the comparison is made entirely between hashed values, the system is able to establish relevance or connection between the query and the user profile without exposing or decrypting any sensitive information. This enables secure, privacy-preserving profile matching that can power intelligent response generation, user clustering, or alert routing within encrypted platforms.

In some embodiments, the system may determine that the first token corresponds to the first indicium of the first knowledgeless data profile by determining a first homomorphically encrypted vector corresponding to the first portion, determining a second homomorphically encrypted vector corresponding to text in the first query, determining the first indicium based on the first homomorphically encrypted vector, determining the first token based on the second homomorphically encrypted vector, and comparing the first token to the first indicium. For example, the system may determine that a first token corresponds to a first indicium of a first knowledgeless data profile by leveraging homomorphic encryption, which allows computations to be performed on encrypted data without decrypting it. The process begins with the system identifying a first portion of the knowledgeless data profile—such as an attribute representing a user's industry, past cybersecurity incident, or behavioral trait—and encoding it into a first homomorphically encrypted vector. This vector securely represents the feature in a way that can participate in mathematical operations, such as similarity comparisons or distance calculations, without ever exposing the underlying data. Simultaneously, the system processes the first query—for example, a message like “Have any healthcare organizations seen ransomware attacks?”—and extracts relevant text associated with potential incidents or domains. This extracted text is converted into a second homomorphically encrypted vector, preserving semantic structure and encoding it for secure comparison. The system then derives the first indicium from the first encrypted vector and the first token from the second encrypted vector, treating both as encrypted representations of the user's attributes and the query's context, respectively. Using homomorphic computation, the system performs a comparison between the first token and the first indicium directly in the encrypted space—such as by computing a similarity score, inner product, or matching function—without decrypting either vector. If the result of this encrypted comparison meets a predefined threshold (e.g., semantic similarity or categorical alignment), the system determines that the first token corresponds to the first indicium. This outcome signals that the profile is contextually relevant to the query, enabling secure user matching, incident correlation, or intelligent routing within a privacy-preserving system architecture. Through this method, the system maintains full data confidentiality while still enabling accurate and meaningful interactions across encrypted user profiles and queries.

In some embodiments, the system may determine that the first token corresponds to the first indicium of the first knowledgeless data profile by determining a first cryptographic proof corresponding to the first portion, determining a first cryptographic claim corresponding to text in the first query, determining the first indicium based on the first cryptographic proof, determining the first token based on the first cryptographic claim, and comparing the first token to the first token by validating the first cryptographic proof against the first cryptographic claim. For example, the system may determine that a first token corresponds to a first indicium of a first knowledgeless data profile by leveraging cryptographic proof techniques, such as zero-knowledge proofs (ZKPs), to securely establish a match between a user profile and a query without revealing sensitive data. The process begins with the system identifying a first portion of the knowledgeless data profile—such as information indicating that a user has experienced a particular type of cybersecurity incident or is affiliated with a specific sector. This portion is used to generate a first cryptographic proof, which mathematically demonstrates that a condition or attribute exists within the profile without exposing the underlying data. Concurrently, the system parses the first query, such as “Are any healthcare organizations seeing ransomware attacks?” and derives from it a first cryptographic claim. This claim represents an assertion that some characteristic is being requested or queried—such as a claim that a user belongs to the healthcare sector or has encountered a ransomware event. The first indicium is derived from the cryptographic proof generated from the profile, while the first token is constructed based on the cryptographic claim extracted from the query. To determine whether the first token corresponds to the first indicium, the system performs a validation step in which the first cryptographic proof is evaluated against the first cryptographic claim. This validation is carried out using a secure, verifiable cryptographic protocol that checks whether the profile's proof satisfies the conditions expressed in the claim, without either party revealing sensitive content. If the proof is successfully validated against the claim, the system concludes that the first token corresponds to the first indicium, meaning the knowledgeless data profile is relevant to the incident or context expressed in the query. This approach enables secure, privacy-preserving linkage between encrypted user profiles and real-time queries, facilitating intelligent filtering, alerting, or collaboration without compromising user confidentiality or data integrity.

In some embodiments, the system may determine that the first token corresponds to the first indicium of the first knowledgeless data profile by determining a first plurality of encrypted values corresponding to the first indicium, determining a second plurality of encrypted values corresponding to the first token, determining corresponding values between the first plurality of encrypted values and the second plurality of encrypted values, and comparing the first token to the first indicium based on the corresponding values. For example, the system may determine that a first token corresponds to a first indicium of a first knowledgeless data profile by analyzing encrypted value sets that represent encoded characteristics from both the user profile and the query context. The process begins with the system identifying the first indicium within the knowledgeless data profile and extracting a first plurality of encrypted values that collectively represent different aspects or attributes of a first portion of the profile—such as encoded indicators of industry sector, incident history, behavioral signatures, or other contextual elements. Simultaneously, the system processes the first token—derived from a user query or communication—and generates a second plurality of encrypted values that represent the token's semantic or categorical meaning in encrypted form. Using privacy-preserving matching algorithms, the system then evaluates these two encrypted sets to identify corresponding values between them. This step may involve homomorphic operations, secure set intersection techniques, or encrypted similarity scoring to detect overlap or alignment between the encrypted features of the token and those of the indicium. For example, if both sets encode references to the same incident type, geographic region, or threat actor—albeit in encrypted form—the system will detect these correspondences without revealing any plaintext values. Once the system establishes a sufficient number or strength of corresponding values between the two encrypted sets, it proceeds to compare the first token to the first indicium based on the presence and quality of these matches. If the comparison meets a predefined threshold for relevance or similarity, the system concludes that the first token corresponds to the first indicium. This approach enables the system to securely and accurately associate user profiles with incident-related queries or categories, allowing for intelligent routing, alerting, or grouping—while maintaining full confidentiality and compliance with data privacy requirements.

In some embodiments, the system may determine that the first token corresponds to the first indicium of the first knowledgeless data profile by determining a first noisy statistical summary corresponding to the first indicium, determining a second noisy statistical summary corresponding to the first token, and comparing the first noisy statistical summary to the second noisy statistical summary. For example, the system may determine that a first token corresponds to a first indicium of a first knowledgeless data profile by leveraging noisy statistical summaries that preserve privacy while allowing approximate comparisons. In this approach, the system first identifies the first indicium within the knowledgeless data profile, which represents an encoded attribute or behavior—such as incident frequency, risk exposure level, or geographic distribution. Instead of using raw data, the system generates a first noisy statistical summary of this indicium, applying techniques from differential privacy to add controlled randomness (noise) that obscures individual-level information while preserving aggregate trends or patterns. Simultaneously, the system processes the first token, which is derived from a query or communication, and generates a second noisy statistical summary that reflects the statistical characteristics of the token's context—such as the average rate of a particular incident in a region or industry, or the observed frequency of a certain attack type. This summary is generated using similar privacy-preserving methods to ensure consistency and security. The system then compares the first and second noisy statistical summaries using similarity metrics such as Euclidean distance, cosine similarity, or probabilistic overlap measures. Despite the added noise, if the two summaries demonstrate a statistically significant alignment or fall within an acceptable similarity threshold, the system concludes that the first token corresponds to the first indicium. This means the encrypted or anonymized data in the knowledgeless profile is contextually relevant to the information or intent conveyed in the query. By using noisy summaries, the system can perform meaningful inferences while maintaining robust privacy protections, enabling secure user matching, profiling, and threat correlation in privacy-sensitive environments.

In some embodiments, the system may determine that the first token corresponds to the one or more of the first plurality of indicia and the second plurality of indicia by comparing the first token to the first plurality of indicia and determining a similarity score based on comparing the first token to the first plurality of indicia. For example, the system may determine that a first token corresponds to one or more of the first plurality of indicia and the second plurality of indicia by performing a similarity-based comparison across encoded elements within multiple knowledgeless data profiles. The process begins by analyzing the first token, which may be derived from a user query, communication, or system-generated alert, and represents a concept such as a cybersecurity incident type, targeted industry, behavior pattern, or geographic location. The system then compares this token to the first plurality of indicia—a set of privacy-preserving, cryptographically encoded attributes contained within a first knowledgeless data profile—using a matching algorithm designed for secure, non-revealing comparisons. This comparison may involve one or more techniques, such as secure hash matching, encrypted vector similarity, homomorphic operations, or differentially private probability estimations. The system evaluates how closely the semantic or categorical meaning of the token aligns with each indicium and then aggregates the results to generate a similarity score. This score quantifies the level of correspondence between the token and the indicia, while preserving the privacy of both the input and the profiles being compared. The same process is applied to the second plurality of indicia from a second knowledgeless data profile. If the similarity score for either or both sets of indicia exceeds a predefined threshold, the system determines that the first token corresponds to one or more indicia within the knowledgeless profiles. This enables the system to identify contextually relevant users or entities without accessing or exposing raw data, thereby supporting privacy-preserving clustering, recommendation, or alerting in sensitive environments such as cybersecurity, fraud prevention, or cross-industry intelligence sharing.

In some embodiments, the system may determine that the first token corresponds to the one or more of the first plurality of indicia and the second plurality of indicia by comparing the first plurality of indicia to the second plurality of indicia and determining a similarity score based on comparing the first plurality of indicia to the second plurality of indicia. For example, the system may determine that a first token corresponds to one or more of the first plurality of indicia and the second plurality of indicia by directly comparing the two sets of encoded indicia and calculating a similarity score that reflects their degree of alignment. Each knowledgeless data profile—such as one representing a user, organization, or system—includes a plurality of indicia, which are cryptographically encoded or privacy-preserving representations of specific features or attributes, such as incident types encountered, industry affiliation, geographic context, behavioral patterns, or threat exposures. Rather than comparing the first token directly to each profile, the system compares the indicia of two profiles—for example, the indicia from a profile associated with the token's context (e.g., derived from a query or incident report) and another profile in the database. This comparison may involve computing distances or alignment scores between vectors, hashed values, or encrypted tokens using privacy-preserving similarity measures such as cosine similarity, homomorphic distance functions, or secure set intersection. The system evaluates these comparisons pairwise or in aggregate and calculates a similarity score that quantifies the semantic and structural overlap between the two sets of indicia. If the similarity score exceeds a predefined relevance threshold, the system concludes that the first token is likely associated with the compared profiles, because their encoded attributes exhibit meaningful contextual similarity. This approach allows the system to infer token relevance without exposing underlying data and is particularly useful in identifying commonalities between participants in a cyber incident, fraud trend, or other sensitive domain. It enables the system to cluster or link knowledgeless profiles around shared themes—such as shared threat exposure or behavior—based purely on encrypted or anonymized indicators.

At step 508, process 500 (e.g., using one or more components described above) generates a group. For example, the system may, in response to determining that the first token corresponds to the one or more of the first plurality of indicia and the second plurality of indicia, generate a first group comprising the first user and the second user. For example, in response to determining that a first token corresponds to one or more of the first plurality of indicia and the second plurality of indicia, a system may generate a first group comprising a first user and a second user whose respective knowledgeless data profiles exhibit meaningful contextual alignment. Upon establishing that the token—representing a shared concept such as a cybersecurity incident type, fraud vector, geographic threat region, or targeted industry—matches encrypted indicia in both users' profiles, the system infers a relevant connection between them. This connection may indicate that both users are experiencing similar threats, operating within the same sector, or observing comparable anomalies in their environments. Using this inferred similarity, the system programmatically creates a first group by associating the two users in a secure, privacy-respecting manner. This grouping may take the form of a virtual collaboration space, an access-controlled communication channel, or a backend data structure linking users for coordinated response or alerting. The group may also include associated metadata such as the matched token, the similarity score, and time-stamped indicators of relevance. Importantly, the creation of the group does not require disclosure of the users' identities or raw data; instead, the grouping is based on encrypted, privacy-preserving indicia that ensure confidentiality while enabling intelligent clustering. This allows the system to facilitate secure, cross-entity collaboration, enhance situational awareness, or drive automated recommendations among users with verified, shared relevance to a specific threat or inquiry.

In some embodiments, the system may generate the first group, which comprises the first user and the second user by determining a first content control rule for the first group based on the first indicium and the second indicium and filtering communications of the first group based on the first content control rule. For example, the system may generate a first group comprising a first user and a second user by first identifying shared relevance between their knowledgeless data profiles—specifically by determining that a first indicium from the first user's profile and a second indicium from the second user's profile both correspond to a common token, such as a specific cybersecurity incident or fraud type. Once this contextual linkage is established, the system proceeds to determine a first content control rule for the newly formed group. This rule is derived based on the nature, sensitivity, or domain of the matched indicia. For example, if the indicia relate to highly sensitive events such as data breaches in the financial sector, the content control rule may restrict message formats, enforce stricter encryption, or limit sharing of identifiable organizational data. After defining the content control rule, the system applies it to all communications within the group, thereby filtering communications in accordance with predefined privacy, compliance, or operational policies. This may involve redacting certain keywords, applying differential privacy techniques, enforcing role-based message visibility, or blocking outbound content that violates confidentiality constraints. The rule ensures that information exchanged between the users remains relevant to the shared context of the group while also adhering to organizational policies and privacy frameworks. By integrating this control mechanism, the system enables secure, policy-aware collaboration among users whose encrypted indicia indicate shared threat exposure or operational relevance, without compromising data integrity or confidentiality.

In some embodiments, the system may receive a second communication in the encrypted, multi-user platform, wherein the second communication comprises a second query relating to a second incident, parse the second communication to determine a second token describing the second incident, determine that the second token corresponds to the first group, and simultaneously generating for display, in a first user interface corresponding to the first user and a second user interface corresponding to the second user, the second communication. For example, the system may receive a second communication within an encrypted, multi-user platform, where the communication includes a second query relating to a second incident, such as a new cybersecurity event or fraud pattern. Upon receiving this second communication, the system parses its content using natural language processing techniques to extract meaningful context. Through this parsing, the system identifies a second token that describes the nature of the second incident—such as a phrase like “supply chain ransomware” or “credential stuffing in retail.” This token is then analyzed in the context of existing group associations and encrypted user profile data. The system determines that the second token corresponds to the first group by matching it to the previously identified indicia within the knowledgeless data profiles of the first and second users. This match may be based on encrypted similarity scoring, hashed token comparisons, or semantic overlap in differentially private summaries. Once this correspondence is confirmed, the system simultaneously generates the second communication for display in both the first user interface—which corresponds to the first user—and the second user interface—which corresponds to the second user. This ensures that both users are notified in real time of a relevant new communication related to a shared context, such as an emerging threat or evolving incident. Because the system operates within an encrypted framework, the delivery and display of the communication are secured, and any associated metadata or control rules ensure the content is presented in accordance with privacy-preserving constraints. This process enables rapid, targeted dissemination of critical intelligence across a trusted group, while maintaining strict control over confidentiality and data exposure.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 5.

The above-described embodiments of the present disclosure are presented for purposes of illustration and not of limitation, and the present disclosure is limited only by the claims that follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:
1. A method for method for using knowledgeless data profiles for real-time detection and sanitized communications.
2. The method of the preceding embodiment, further comprising: receiving a first communication in an encrypted, multi-user platform, wherein the first communication comprises a first query relating to a first incident; parsing the first communication to determine a first token describing the first incident; retrieving a first knowledgeless data profile, wherein the first knowledgeless data profile comprises a first privacy-preserving, cryptographically encoded representation of a first user; retrieving a second knowledgeless data profile, wherein the second knowledgeless data profile comprises a second privacy-preserving, cryptographically encoded representation of a second user; determining that the first token corresponds to a first indicium of the first knowledgeless data profile, wherein the first indicium represents a first portion of the first privacy-preserving, cryptographically encoded representation; determining that the first token corresponds to a second indicium of the second knowledgeless data profile, wherein the second indicium represents a second portion of the second privacy-preserving, cryptographically encoded representation; and in response to determining that the first token corresponds to the first indicium and the second indicium, generating a first group comprising the first user and the second user.
3. The method of any one the preceding embodiments, wherein determining that the first token corresponds to the first indicium of the first knowledgeless data profile further comprises: determining a first characteristic corresponding to the first token; selecting the first indicium, from a plurality of indicia from the first knowledgeless data profile, based on the first indicium corresponding to the first characteristic; and comparing the first characteristic to the first indicium.
4. The method of any one the preceding embodiments, wherein determining that the first token corresponds to the first indicium of the first knowledgeless data profile further comprises: determining a first geographic region corresponding to the first token; and determining that the first indicium corresponds to the first geographic region.
5. The method of any one the preceding embodiments, wherein determining that the first token corresponds to the first indicium of the first knowledgeless data profile further comprises: determining a first cybersecurity incident type corresponding to the first token; and determining that the first indicium corresponds to the first cybersecurity incident type.
6. The method of any one the preceding embodiments, wherein determining that the first token corresponds to the first indicium of the first knowledgeless data profile further comprises: determining a first targeted entity corresponding to the first token; and determining that the first indicium corresponds to the first targeted entity.
7. The method of any one the preceding embodiments, wherein determining that the first token corresponds to the first indicium of the first knowledgeless data profile further comprises: determining a first cryptographic hash corresponding to the first portion; determining a second cryptographic hash corresponding to text in the first query; determining the first indicium based on the first cryptographic hash; determining the first token based on the second cryptographic hash; and comparing the first token to the first indicium.
8. The method of any one the preceding embodiments, wherein determining that the first token corresponds to the first indicium of the first knowledgeless data profile further comprises: determining a first homomorphically encrypted vector corresponding to the first portion; determining a second homomorphically encrypted vector corresponding to text in the first query; determining the first indicium based on the first homomorphically encrypted vector; determining the first token based on the second homomorphically encrypted vector; and comparing the first token to the first indicium.
9. The method of any one the preceding embodiments, wherein determining that the first token corresponds to the first indicium of the first knowledgeless data profile further comprises: determining a first cryptographic proof corresponding to the first portion; determining a first cryptographic claim corresponding to text in the first query; determining the first indicium based on the first cryptographic proof; determining the first token based on the first cryptographic claim; and comparing the first token to the first token by validating the first cryptographic proof against the first cryptographic claim.
10. The method of any one the preceding embodiments, wherein determining that the first token corresponds to the first indicium of the first knowledgeless data profile further comprises: determining a first plurality of encrypted values corresponding to the first indicium; determining a second plurality of encrypted values corresponding to the first token; determining corresponding values between the first plurality of encrypted values and the second plurality of encrypted values; and comparing the first token to the first indicium based on the corresponding values.
11. The method of any one the preceding embodiments, wherein determining that the first token corresponds to the first indicium of the first knowledgeless data profile further comprises: determining a first noisy statistical summary corresponding to the first indicium; determining a second noisy statistical summary corresponding to the first token; and comparing the first noisy statistical summary to the second noisy statistical summary.
12. The method of any one the preceding embodiments, further comprising: receiving a second communication in the encrypted, multi-user platform, wherein the second communication comprises a second query relating to a second incident; parsing the second communication to determine a second token describing the second incident; determining that the second token corresponds to the first group; and simultaneously generating for display, in a first user interface corresponding to the first user and a second user interface corresponding to the second user, the second communication.
13. The method of any one the preceding embodiments, wherein parsing the first communication to determine the first token describing the first incident further comprises: determining first text in the first query; determining second text in the second query; and inputting the first text and the second text into a large language model to determine a first context of the first query; and determining the first token based on the first context.
14. The method of any one the preceding embodiments, wherein generating the first group comprises the first user and the second user further comprises: determining a first content control rule for the first group based on the first indicium and the second indicium; and filtering communications of the first group based on the first content control rule.
15. The method of any one the preceding embodiments, wherein retrieving the first knowledgeless data profile further comprises: receiving the first privacy-preserving, cryptographically encoded representation; validating the first privacy-preserving, cryptographically encoded representation; and determining to generate the first knowledgeless data profile based on validating the first privacy-preserving, cryptographically encoded representation.
16. The method of any one the preceding embodiments, wherein receiving the first communication further comprises: receiving incident data from a plurality of sources; generating a feature input for a first model based on the incident data, wherein the first model is trained to identify potential incidents based on the incident data; inputting the feature input into the first model to generate a first output; and generating the first query based on the first output.
17. The method of any one the preceding embodiments, wherein retrieving the first knowledgeless data profile further comprises: receiving a plurality of indicia corresponding to a plurality of users; generating a feature input for a first model based on the first token and the plurality of indicia, wherein the first model is trained to identify likelihood of users corresponding to inputted tokens; inputting the feature input into the first model to generate a first output, wherein the first output comprises a first likelihood that the first user corresponds to the first token; comparing the first likelihood to a threshold likelihood; and determining to retrieve the first knowledgeless data profile based on comparing the first likelihood to a threshold likelihood.
18. The method of any one the preceding embodiments comprising: retrieving a first knowledgeless data profile, wherein the first knowledgeless data profile comprises a first privacy-preserving, cryptographically encoded representation of a first user, wherein the first privacy-preserving, cryptographically encoded representation comprises a first plurality of indicia, and wherein each of the first plurality of indicia represent first respective portions of the first privacy-preserving, cryptographically encoded representation; retrieving a second knowledgeless data profile, wherein the second knowledgeless data profile comprises a second privacy-preserving, cryptographically encoded representation of a second user, wherein the second privacy-preserving, cryptographically encoded representation comprises a second plurality of indicia, and wherein each of the second plurality of indicia represent second respective portions of the second privacy-preserving, cryptographically encoded representation; determining that a first token corresponds to one or more of the first plurality of indicia and the second plurality of indicia; and in response to determining that the first token corresponds to the one or more of the first plurality of indicia and the second plurality of indicia, generating a first group comprising the first user and the second user.
19. The method of any one the preceding embodiments, wherein determining that the first token corresponds to the one or more of the first plurality of indicia and the second plurality of indicia further comprises: comparing the first token to the first plurality of indicia; and determining a similarity score based on comparing the first token to the first plurality of indicia.
20. The method of any one the preceding embodiments, wherein determining that the first token corresponds to the one or more of the first plurality of indicia and the second plurality of indicia further comprises: comparing the first plurality of indicia to the second plurality of indicia; and determining a similarity score based on comparing the first plurality of indicia to the second plurality of indicia.
21. One or more non-transitory, computer-readable mediums storing instructions that, when executed by a data processing apparatus, cause the data processing apparatus to perform operations comprising those of any of embodiments 1-20.
22. A system comprising one or more processors; and memory storing instructions that, when executed by the processors, cause the processors to effectuate operations comprising those of any of embodiments 1-20.
23. A system comprising means for performing any of embodiments 1-20.

What is claimed is:

1. A system for using knowledgeless data profiles for real-time detection and sanitized communications, the system comprising:
one or more processors; and
one or more non-transitory, computer-readable mediums comprising instructions that when executed by the one or more processors cause operations comprising:
receiving a first communication in an encrypted, multi-user platform, wherein the first communication comprises a first query relating to a cybersecurity incident;
parsing the first communication to determine a first token describing the cybersecurity incident;
retrieving a first knowledgeless data profile, wherein the first knowledgeless data profile comprises a first privacy-preserving, cryptographically encoded representation of a first user;
retrieving a second knowledgeless data profile, wherein the second knowledgeless data profile comprises a second privacy-preserving, cryptographically encoded representation of a second user;
determining that the first token corresponds to a first indicium of the first knowledgeless data profile, wherein the first indicium represents a first portion of the first privacy-preserving, cryptographically encoded representation;
determining that the first token corresponds to a second indicium of the second knowledgeless data profile, wherein the second indicium represents a second portion of the second privacy-preserving, cryptographically encoded representation;
in response to determining that the first token corresponds to the first indicium and the second indicium, generating a first group comprising the first user and the second user; and
simultaneously generating for display, in a first user interface corresponding to the first user and a second user interface corresponding to the second user, the first communication.

2. A method for using knowledgeless data profiles for real-time detection and sanitized communications, the method comprising:
receiving a first communication in an encrypted, multi-user platform, wherein the first communication comprises a first query relating to a first incident;
parsing the first communication to determine a first token describing the first incident;
retrieving a first knowledgeless data profile, wherein the first knowledgeless data profile comprises a first privacy-preserving, cryptographically encoded representation of a first user;
retrieving a second knowledgeless data profile, wherein the second knowledgeless data profile comprises a second privacy-preserving, cryptographically encoded representation of a second user;
determining that the first token corresponds to a first indicium of the first knowledgeless data profile, wherein the first indicium represents a first portion of the first privacy-preserving, cryptographically encoded representation;
determining that the first token corresponds to a second indicium of the second knowledgeless data profile, wherein the second indicium represents a second portion of the second privacy-preserving, cryptographically encoded representation; and
in response to determining that the first token corresponds to the first indicium and the second indicium, generating a first group comprising the first user and the second user.

3. The method of claim 2, wherein determining that the first token corresponds to the first indicium of the first knowledgeless data profile further comprises:
determining a first characteristic corresponding to the first token;
selecting the first indicium, from a plurality of indicia from the first knowledgeless data profile, based on the first indicium corresponding to the first characteristic; and
comparing the first characteristic to the first indicium.

4. The method of claim 2, wherein determining that the first token corresponds to the first indicium of the first knowledgeless data profile further comprises:
determining a first geographic region corresponding to the first token; and
determining that the first indicium corresponds to the first geographic region.

5. The method of claim 2, wherein determining that the first token corresponds to the first indicium of the first knowledgeless data profile further comprises:
determining a first cybersecurity incident type corresponding to the first token; and
determining that the first indicium corresponds to the first cybersecurity incident type.

6. The method of claim 2, wherein determining that the first token corresponds to the first indicium of the first knowledgeless data profile further comprises:
determining a first targeted entity corresponding to the first token; and
determining that the first indicium corresponds to the first targeted entity.

7. The method of claim 2, wherein determining that the first token corresponds to the first indicium of the first knowledgeless data profile further comprises:
determining a first cryptographic hash corresponding to the first portion;
determining a second cryptographic hash corresponding to text in the first query;
determining the first indicium based on the first cryptographic hash;
determining the first token based on the second cryptographic hash; and
comparing the first token to the first indicium.

8. The method of claim 2, wherein determining that the first token corresponds to the first indicium of the first knowledgeless data profile further comprises:
determining a first homomorphically encrypted vector corresponding to the first portion;
determining a second homomorphically encrypted vector corresponding to text in the first query;
determining the first indicium based on the first homomorphically encrypted vector;
determining the first token based on the second homomorphically encrypted vector; and
comparing the first token to the first indicium.

9. The method of claim 2, wherein determining that the first token corresponds to the first indicium of the first knowledgeless data profile further comprises:
determining a first cryptographic proof corresponding to the first portion;
determining a first cryptographic claim corresponding to text in the first query;
determining the first indicium based on the first cryptographic proof;
determining the first token based on the first cryptographic claim; and
comparing the first token to the first token by validating the first cryptographic proof against the first cryptographic claim.

10. The method of claim 2, wherein determining that the first token corresponds to the first indicium of the first knowledgeless data profile further comprises:
determining a first plurality of encrypted values corresponding to the first indicium;
determining a second plurality of encrypted values corresponding to the first token;
determining corresponding values between the first plurality of encrypted values and the second plurality of encrypted values; and
comparing the first token to the first indicium based on the corresponding values.

11. The method of claim 2, wherein determining that the first token corresponds to the first indicium of the first knowledgeless data profile further comprises:
determining a first noisy statistical summary corresponding to the first indicium;
determining a second noisy statistical summary corresponding to the first token; and
comparing the first noisy statistical summary to the second noisy statistical summary.

12. The method of claim 2, further comprising:
receiving a second communication in the encrypted, multi-user platform, wherein the second communication comprises a second query relating to a second incident;
parsing the second communication to determine a second token describing the second incident;
determining that the second token corresponds to the first group; and
simultaneously generating for display, in a first user interface corresponding to the first user and a second user interface corresponding to the second user, the second communication.

13. The method of claim 2, wherein parsing the first communication to determine the first token describing the first incident further comprises:
determining first text in the first query;
determining second text in the first query;
inputting the first text and the second text into a large language model to determine a first context of the first query; and
determining the first token based on the first context.

14. The method of claim 2, wherein generating the first group comprises the first user and the second user further comprises:
determining a first content control rule for the first group based on the first indicium and the second indicium; and
filtering communications of the first group based on the first content control rule.

15. The method of claim 2, wherein retrieving the first knowledgeless data profile further comprises:
receiving the first privacy-preserving, cryptographically encoded representation;
validating the first privacy-preserving, cryptographically encoded representation; and
determining to generate the first knowledgeless data profile based on validating the first privacy-preserving, cryptographically encoded representation.

16. The method of claim 2, wherein receiving the first communication further comprises:
receiving incident data from a plurality of sources;
generating a feature input for a first model based on the incident data, wherein the first model is trained to identify potential incidents based on the incident data;
inputting the feature input into the first model to generate a first output; and
generating the first query based on the first output.

17. The method of claim 2, wherein retrieving the first knowledgeless data profile further comprises:
receiving a plurality of indicia corresponding to a plurality of users;
generating a feature input for a first model based on the first token and the plurality of indicia, wherein the first model is trained to identify likelihood of users corresponding to inputted tokens;
inputting the feature input into the first model to generate a first output, wherein the first output comprises a first likelihood that the first user corresponds to the first token;
comparing the first likelihood to a threshold likelihood; and
determining to retrieve the first knowledgeless data profile based on comparing the first likelihood to the threshold likelihood.

18. One or more non-transitory, computer-readable media comprising instructions that when executed by one or more processors cause operations comprising:
retrieving a first knowledgeless data profile, wherein the first knowledgeless data profile comprises a first privacy-preserving, cryptographically encoded representation of a first user, wherein the first privacy-preserving, cryptographically encoded representation comprises a first plurality of indicia, and wherein each of the first plurality of indicia represent first respective portions of the first privacy-preserving, cryptographically encoded representation;
retrieving a second knowledgeless data profile, wherein the second knowledgeless data profile comprises a second privacy-preserving, cryptographically encoded representation of a second user, wherein the second privacy-preserving, cryptographically encoded representation comprises a second plurality of indicia, and wherein each of the second plurality of indicia represent second respective portions of the second privacy-preserving, cryptographically encoded representation;
determining that a first token corresponds to one or more of the first plurality of indicia and the second plurality of indicia; and
in response to determining that the first token corresponds to the one or more of the first plurality of indicia and the second plurality of indicia, generating a first group comprising the first user and the second user.

19. The one or more non-transitory, computer-readable media of claim 18, wherein determining that the first token corresponds to the one or more of the first plurality of indicia and the second plurality of indicia further comprises:
comparing the first token to the first plurality of indicia; and
determining a similarity score based on comparing the first token to the first plurality of indicia.

20. The one or more non-transitory, computer-readable media of claim 18, wherein determining that the first token corresponds to the one or more of the first plurality of indicia and the second plurality of indicia further comprises:
comparing the first plurality of indicia to the second plurality of indicia; and
determining a similarity score based on comparing the first plurality of indicia to the second plurality of indicia.
